(19) United States
(12) Patent Application Publication
(10) Pub. No.: US 2013/0024094 A1
(43) Pub. Date: Jan. 24, 2013

(54) METHODS FOR CONTROLLING COMBUSTION OF BLENDED BIOFUELS

(71) Applicants: Gregory Matthew Shaver, Lafayette, IN (US); David Benjamin Snyder, Franklin, IN (US); Carrie Michele Hall, Lafayette, IN (US); Gayatri Adi, West Lafayette, IN (US); Michael Bunce, Knoxville, TN (US)

(72) Inventors: Gregory Matthew Shaver, Lafayette, IN (US); David Benjamin Snyder, Franklin, IN (US); Carrie Michele Hall, Lafayette, IN (US); Gayatri Adi, West Lafayette, IN (US); Michael Bunce, Knoxville, TN (US)

(21) Appl. No.: 13/519,756

(22) PCT Filed: Dec. 31, 2010
(86) PCT No.: PCT/US10/62628

§ 371 Date: Oct. 9, 2012

Related U.S. Application Data
(60) Provisional application No. 61/291,383, filed on Dec. 31, 2009.

(51) Int. Cl. F02B 47/08; F02M 25/07; F02D 41/30

(52) U.S. Cl. 701/104; 701/103

(57) ABSTRACT

A closed-loop control algorithm that reduces the increases in nitrogen oxides (NOₓ) commonly observed with biodiesel combustion while retaining particulate matter (PM) reductions with variable biodiesel blend fractions. One embodiment includes a control algorithm that is closed-loop with regards to combustible oxygen mass fraction (COMF) instead of exhaust gas recirculation (EGR) fraction. Yet another algorithm includes biodiesel blend estimation and “fuel-flexible” accommodation. A physics-based model has also been developed which predicts experimentally observed engine performance and emissions for biodiesel.

### CROSS REFERENCE TO RELATED APPLICATION

This application claims the benefit of priority to U.S. Provisional Patent Application Ser. No. 61/291,383, filed Dec. 31, 2009, incorporated herein by reference.

### FIELD OF THE INVENTION

Some embodiments of the present invention pertain to control methodologies for internal combustion engines using different types of fuel, and in particular some embodiments pertain to the control of diesel engines operated with different blends of petroleum-based diesel fuel and biodiesel fuel.

### BACKGROUND OF THE INVENTION

A large part of the world's total energy demand is from the transportation sector which is predominantly accommodated with petroleum-based fuels. Alternative fuels are now gaining importance as a means of reducing petroleum dependence and greenhouse gas emissions. Biodiesel, a renewable fuel produced from plant or animal fats, has several advantages as an alternative fuel in diesel engines. However, differences in combustion performance and emissions are observed as a result of fuel property differences, (including molecular composition, cetane number, distillation temperatures, heating value, heat of vaporization, and bulk modulus, among others).

Biodiesel mixes well with diesel and results in reductions in net carbon-dioxide (CO₂) since biodiesel feedstock crops consume CO₂ from the atmosphere during their growth. Furthermore, biodiesel is an oxygenated fuel containing approximately 11% oxygen by weight, which is believed to yield more complete combustion resulting in lower carbon monoxide (CO), unburned hydrocarbons (UHC) and PM emissions. Biodiesel can have lower energy density and generally higher NOₓ emissions than conventional diesel for many operating conditions. The calorific value for biodiesel is about 12% lower than that for diesel, which means that more biodiesel fuel is required to achieve the same amount of torque or power compared to diesel fuel.

One potential problem with the use of biodiesel is that the blend ratio of a petroleum-based diesel fuel with a biofuel can vary as the operator of the engine supplies the engine with blended fuel purchased from different vendors or at different times. The output characteristics of the engine change as a result of the use of different fuel blends. If these operating differences are not accounted for, it is possible that the operator could be dissatisfied with performance of the engine, or that the exhaust emissions of the engine may be excessive.

What is needed are engine control methods that take into account the characteristics of the fuel. Various embodiments of the present invention do this in novel and non-obvious ways.

### SUMMARY OF THE INVENTION

One aspect of this work was to improve the combustion characteristics of alternative diesel fuels by estimating and accommodating various blends of biofuels in a diesel engine. In various embodiments in the present invention, there is an exhaust O2-based estimation algorithm used for, on-board blend fraction estimation; Biodiesel blends can be accommodated in a modern diesel engine so that emissions & noise are reduced and fuel consumption is minimized.

A closed-loop control strategy according to one embodiment of the present invention can eliminate biodiesel-induced NOx (a smog generating chemical) increases, and reduce fuel consumption, while retaining particulate matter (PM) reductions with variable biodiesel blend fractions in a manner requiring little or no added calibration effort.

Some embodiments of the present invention include that through a change of closed-loop control variables: 1) combustible oxygen mass fraction (COMF) instead of exhaust gas recirculation (EGR) fraction, and 2) injected fuel energy instead of injected fuel mass, the NOx increases for any biodiesel blend fraction can be mitigated in a generalizable way, sometimes without the need for additional engine calibration.

One approach includes two parts: biodiesel blend estimation and “fuel-flexible” accommodation. Estimation refers to the process by which the engine control module (ECM) is informed of the blend fraction of biodiesel that is present in the fuel blend. Accommodation refers to the process by which the ECM changes the engine settings in such a way that the combustion performance of biodiesel blends is modified. Various embodiments of the present invention enable the clean and efficient use of a renewable, domestically available fuel by mitigating two often-cited aspects of biodiesel—increases in NOₓ emissions and fuel consumption.

One aspect of the present invention pertains to a method of controlling an internal combustion engine. Some embodiments include providing an electronic controller for operating the engine with a first control loop closed on the recirculation of exhaust gas into cylinder or the amount of fuel provided into the cylinder. The engine is operated with a fuel that is a blend of a petroleum-based fuel and a biomass-derived fuel. Yet other embodiments include estimating the amount of the biomass-derived fuel with the controller, and modifying operation of the first loop in response to the estimated amount.

Another aspect of the present invention pertains to a method for controlling an internal combustion engine. Some embodiments include an electronic controller operating an engine with an electronically actuatable fuel injector. Yet other embodiments include estimating the energy content of the fuel, and operating the engine to provide a predetermined amount of energy to the engine with the injector.

Yet another aspect of the present invention pertains to a method of controlling an internal combustion engine, having at least one cylinder and an electronic controller, and operating the engine with a fuel containing oxygen. Still other embodiments include estimating the rate of fuel flow into the engine with the controller, and estimating the rate of ambient air flow into the engine with the controller, calculating a number by the controller corresponding to the amount of combustible oxygen being provided to the cylinder.

Still other aspects of the present invention pertain to a method for controlling an internal combustion engine. Some embodiments include providing an internal combustion engine and an electronic controller operating the engine with an electronically actuatable fuel injector. Other embodiments include, determining that the fuel includes a biofuel from said measuring, and compensating for the biofuel by injecting additional fuel into the engine.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions. Further, some of the figures shown herein may have been created from scaled drawings. It is understood that such dimensions, or the relative scaling within a figure, are by way of example, and not to be construed as limiting.

FIG. 5.1 shows a basic overview of ECM decision-making process.

FIG. 5.2 shows an engine torque curve and operating conditions.

FIG. 5.3 shows nominal B100 engine performance (no change to ECM decision-making).

FIG. 5.4 shows nominal B20 engine performance (no change to ECM decision-making).

FIG. 5.5 shows nominal B5 engine performance (no change to ECM decision-making).

FIG. 6.2 is a graphical representation showing BSNOx vs. combustible oxygen mass fraction for B0.

FIG. 6.3 is a graphical representation showing BSNOx vs. combustible oxygen mass fraction for B0, B5, B20, & B100.

FIG. 6.4.1 shows an example of modified injection profiles according to another embodiment of the present invention.

FIG. 6.4.2 shows an example of modified injection profiles according to another embodiment of the present invention.

FIG. 6.4.3 shows an example of modified injection profiles according to yet another embodiment of the present invention.

FIG. 6.5 shows B100 cycle-weighted average results: torque, brake thermal efficiency (BTE), brake specific NOx (BSNOx), brake specific particulate matter (BSPM), and combustion noise (CN).

FIG. 6.6 shows B100 experimental results of control variable based blend accommodation: torque.

FIG. 6.7 shows B100 experimental results of control variable based blend accommodation: brake specific nitrogen oxides (BSNOx).

FIG. 6.8 shows B100 experimental results of control variable based blend accommodation: brake specific particulate matter (BSPM).

FIG. 6.9 shows B100 experimental results of control variable based blend accommodation: combustion noise (CN).

FIG. 6.10 shows B20 cycle-weighted average results: torque, brake thermal efficiency (BTE), brake specific NOx, (BSNOx), brake specific particulate matter (BSPM), and combustion noise (CN).

FIG. 6.11 shows B5 cycle-weighted average results: torque, brake thermal efficiency (BTE), brake specific NO, (BSNOx), brake specific particulate matter (BSPM), and combustion noise (CN).

FIG. 7.1.1 is a schematic representation of a control system according to one embodiment of the present invention.

FIG. 7.1.2 is a detailed schematic representation of the system of FIG. 7.1.1 according to one embodiment of the present invention.

FIG. 7.1.3 is a schematic representation of a portion of the control system of FIG. 7.1.1.

FIG. 7.1.4 is a schematic representation of a portion of the control system of FIG. 7.1.1 according to one embodiment of the present invention.

FIG. 7.1.5 is a schematic representation of a portion of the control system of FIG. 7.1.1 according to one embodiment of the present invention.

FIG. 7.2 shows a modified testbed with two fuel supply tanks.

FIG. 7.3 shows A25 operating point without accommodation.

FIG. 7.4 shows A25 operating point controlled according to one embodiment of the present invention.

FIG. 7.5 shows A100 operating point without accommodation.

FIG. 7.6 shows A100 operating point controlled according to one embodiment of the present invention.

FIG. 7.7 shows B50 operating point without accommodation.

FIG. 7.8 shows B50 operating point controlled according to one embodiment of the present invention.

FIG. 7.9 shows C100 operating point without accommodation.

FIG. 7.10 shows C100 operating point controlled according to one embodiment of the present invention.

### SYMBOLS AND ABBREVIATIONS

\dot{m} mass flow rate

AFR Air-Fuel Ratio

ATDC After Top Dead Center

BSFC Brake Specific Fuel Consumption

BSNOx Brake Specific NOₓ

BSPM Brake Specific Particulate Matter

BTDC Before Top Dead Center

CAD Crank Angle Degrees

CAN Controller Area Network

CN Combustion Noise

COMF Combustible Oxygen Mass Fraction

DBTDC Degrees Before Top Dead Center

ECM Engine Control Module

EGR Exhaust Gas Recirculation

EOMI End of Main Fuel Injection

HCCI Homogeneous Charge Compression Ignition

LFE Laminar Flow Element

NOx Nitrogen Oxides

NTE Not-To-Exceed

PCCI Premixed Charge Compression Ignition

Peak Dp/dt Peak Rate of Change of In-Cylinder Pressure

PM Particulate Matter

RP Rail Pressure

SET Supplemental Emissions Testing

SI Spark Ignition

SOI Start of Main Fuel Injection

SOMI Start of Main Fuel Injection

TF Total Injected Fuel Mass

VGT Variable Geometry Turbocharger

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims.

The use of an N-series prefix for an element number (NXX.XX) refers to an element that is the same as the non-prefixed element (XX.XX), except as shown and described thereafter. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

Incorporated herein by reference is PCT/US09/52613 filed Aug. 3, 2009, titled FUEL BLEND SENSING SYSTEM, attorney docket no. 17933-90297.

As used herein, the term “mixture fraction” describes the mass ratio of fuel (such as diesel, biodiesel, or a mixture thereof) to air that is directed into the cylinders of the engine. The mixture fraction “f” is defined as the mass flow rate of fuel divided by the total mass flow rate of air and fuel.

As used herein, the term “blend fraction” describes the relative amounts of biodiesel in the fuel blend. Blend fraction is specific to the fuel. The volumetric blend fraction is the volume of biodiesel divided by the total volumetric amount of fuel. As one example, if a gallon of fuel includes 0.25 gallons of biodiesel, then the volumetric blend fraction is 0.25 or 25 percent.

Since biodiesel is an oxygenated fuel and petroleum diesel is not, there are more oxygen atoms present in the cylinder prior to biodiesel blend combustion for a given air to fuel ratio (AFR). Furthermore, post combustion oxygen concentrations will be higher for biodiesel. Theoretical and experimental results indicate that, for a given mixture fraction, the levels of oxygen (O₂) in the exhaust stream of diesel engines are indicative of the amount of biodiesel present in the fuel blend.

A physically-based, experimentally-verified model for estimating the volumetric blend fraction of two fuels has been devised based on fuel composition, exhaust O₂, and mixture fraction information. Mixture fraction is typically a quantity that is known (or at least estimated) by the engine control module (ECM) and the exhaust O₂ mole fraction is easily measured via a stock wideband oxygen sensor. Theoretical results indicate that for typical biodiesel feedstocks, variation in the feedstock results in generally small variations in the exhaust O₂. This biodiesel blend fraction estimation strategy is therefore robust to variation in feedstock.

Various embodiments of the present invention have application in any lean-burn combustion process with blends of two fuels with different stoichiometric air-fuel ratios. Examples include ethanol diesel blends in diesel engines, ethanol-gasoline blends in lean-burn SI or HCCI/PCCI engines, as well as oxygenated fuel blends in non-automotive engines, such as gas turbine engines. The difference in the exhaust O₂ concentration for a particular mixture fraction f provides one basis for estimating the blend fraction of two fuels. There is a larger difference between ethanol and gasoline/diesel than biodiesel and gasoline/diesel—indicating that various embodiments of the present invention pertaining to a dynamic biodiesel blend fraction estimator can be generalized to include estimation with gasoline-ethanol and diesel-ethanol blends.

Conventional mixing-controlled diesel engine combustion generally includes two regions—premixed and diffusion combustion. Premixed combustion is more prevalent early in the process near the flame core, while the majority of the fuel is consumed in a diffusion flame which is stabilized at the lift-off location. For both regions, increased biodiesel flame temperatures are hypothesized to be the primary factor causing the increased NOₓ concentrations for biodiesel. Biodiesel is an oxygenated fuel; hence the stoichiometric oxygen-to-fuel ratio is lower as compared to diesel fuel. Also, due to higher distillation temperatures, biodiesel does not vaporize as readily as diesel; therefore, not as much vaporized fuel is mixed with the air in the early stages of combustion, causing a difference in fuel-to-charge ratios between diesel and biodiesel at the lift-off location. This difference, coupled with the difference in the stoichiometric oxygen-to-fuel ratio between diesel and biodiesel, affects the near-flame equivalence ratios for the two fuels. The equivalence ratio is defined as the ratio of stoichiometric oxygen-to-fuel ratio to the actual oxygen-to-fuel ratio. Because the premixed combustion is rich and equivalence ratios for biodiesel are lower than diesel, biodiesel combustion is closer to stoichiometric, resulting in higher predicted flame temperatures and NOₓ formation rates.

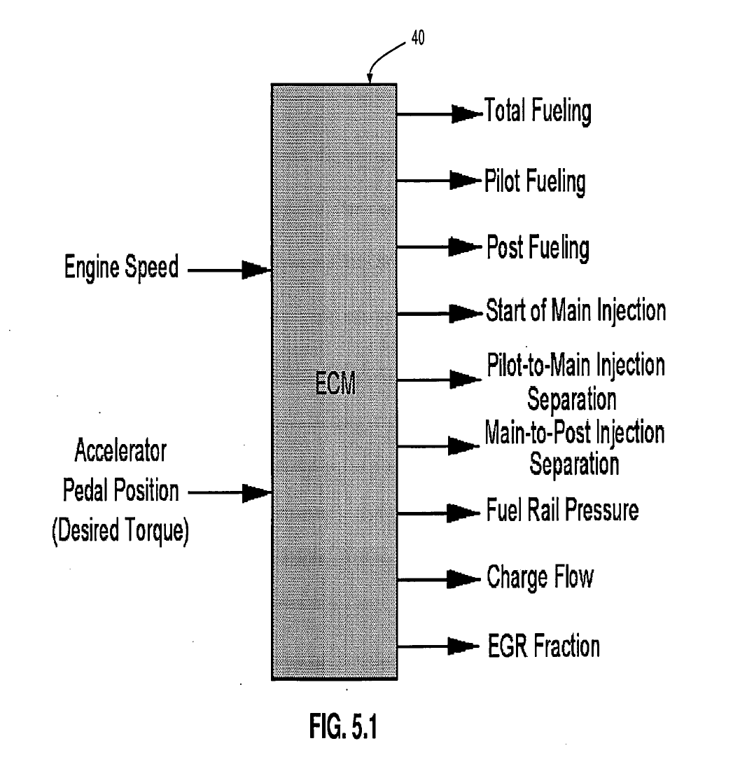

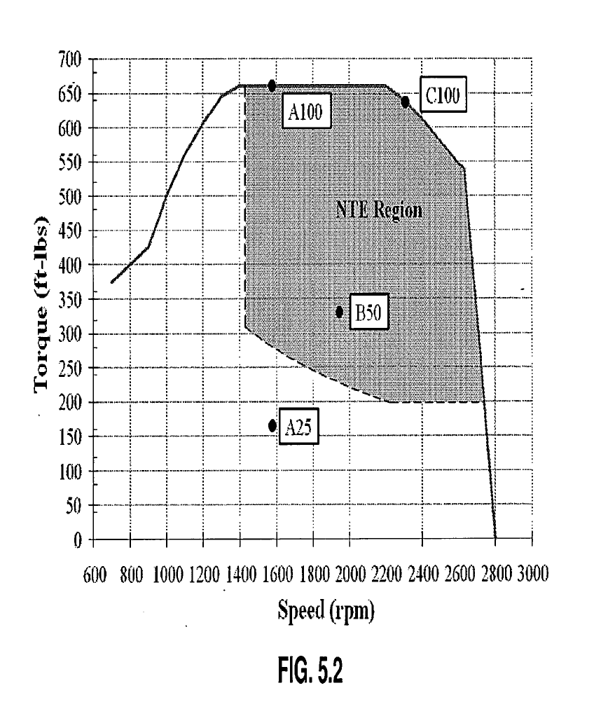

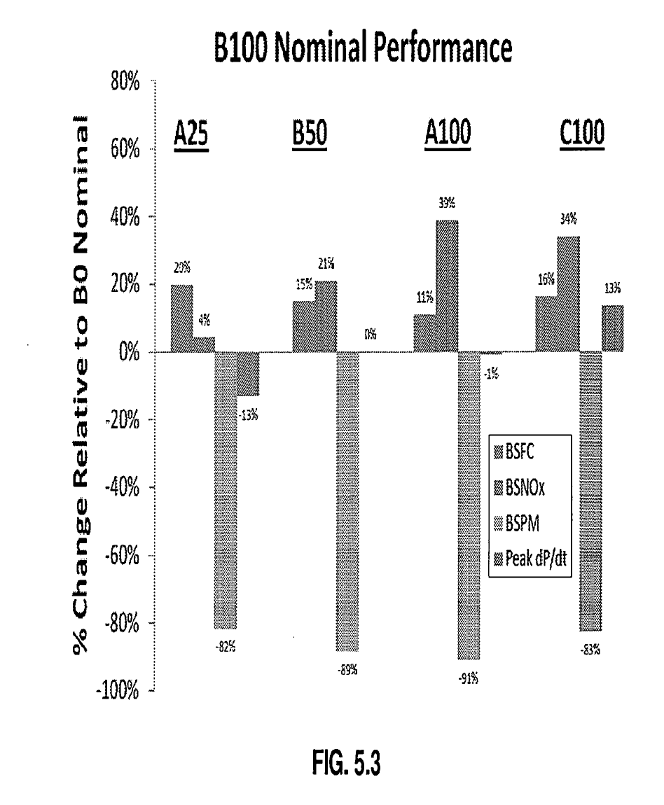

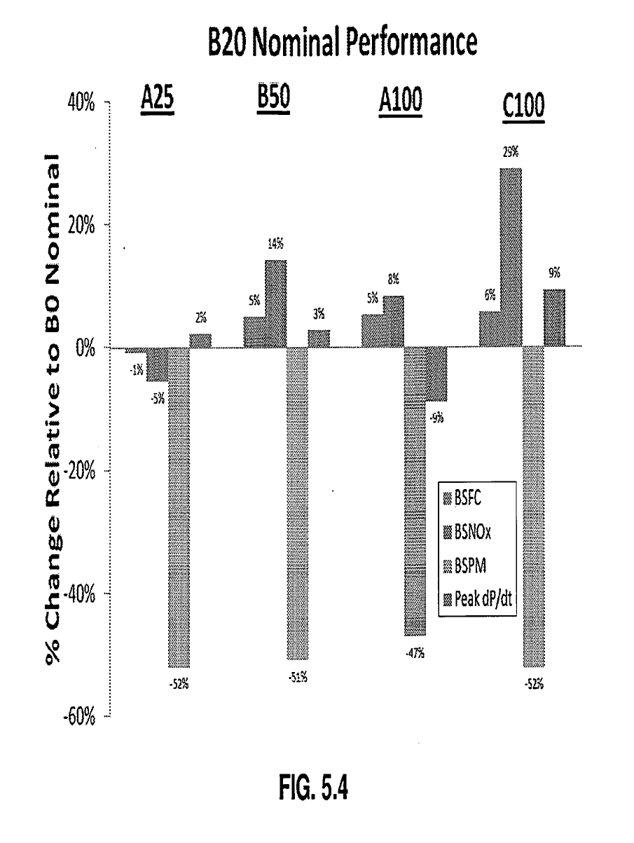

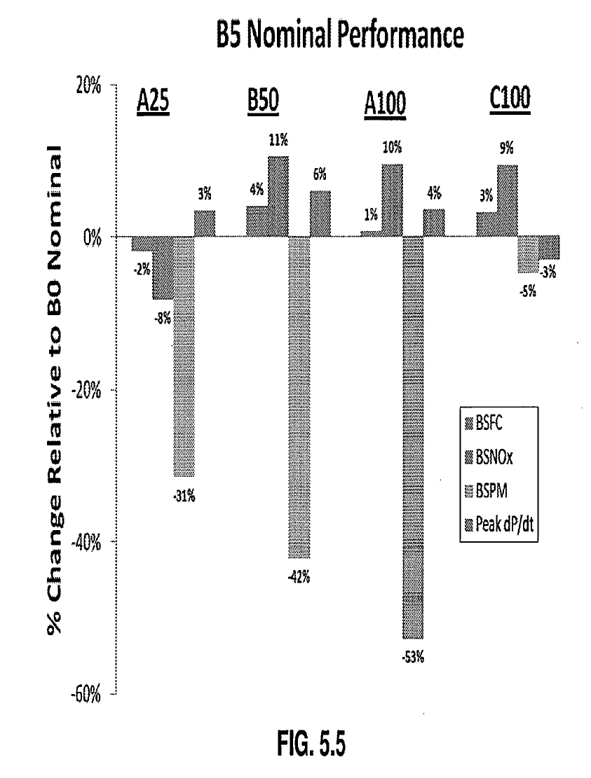

In the diffusion portion of the flame the equivalence ratio at the flame front is often at stoichiometric. Therefore, once the fuel is largely being consumed in a diffusion flame it is relevant to consider the fraction of oxygen that is present. Higher oxygen fractions yield higher combustion temperatures and NOₓ formation rates for diffusion flames. The predicted combustible oxygen mass fraction (COMF) is consistently higher for biodiesel than for diesel during the near-stoichiometric conditions (also true during rich conditions), resulting in increased NOₓ formation. COMF represents the fraction of total oxygen in the cylinder that is available for combustion including the oxygen from the charge and the fuel but not the oxygen atoms associated with the recirculated combustion products. The reason for higher COMF for the biodiesel combustion cases considered here is twofold. First, there is additional oxygen in the flame that is contributed directly by the oxygen in the fuel. Secondly, when EGR is present, the mass fraction of O₂ in the charge gas is higher for biodiesel than for diesel since exhaust O₂ fractions are higher for biodiesel. This is summarized in FIGS. 5.1 and 5.2.

One reason that EGR is effective at reducing NOₓ in diesel combustion is that it lowers the oxygen fraction. Reduced oxygen fractions reduce flame temperatures because, while the flame is still at stoichiometric, more inert species (CO₂, H₂O, etc.) are present to absorb the heat of combustion. In biodiesel combustion, EGR is not as effective at reducing temperature because it is not as effective at reducing oxygen fraction, due to the oxygen present in the fuel and the additional oxygen in the EGR gas following biodiesel combustion. A COMF-based control strategy is presented in some embodiments of the present invention, instead of conventional EGR-based NOₓ control. This strategy leaves other engine control functionality (ECM decision-making maps, EGR fraction, charge flow controllers, etc.) unchanged and adds “oxygen fraction control”, which modulates the EGR fraction and air-to-fuel ratio so that the desired COMF is achieved.

Various embodiments of the present invention demonstrate the validity of a control variable based accommodation strategy pertaining to combustion in an internal combustion engine of a blend of a petroleum-based fuel and a biofuel. The proposed strategy in some embodiments includes replacement of 3 control variables: replacement of EGR fraction with combustible oxygen mass fraction (COMF); replacement of total injected fuel mass with total injected fuel energy; and replacement of start of main injection (SOMI) with end of main injection (EOMI).

The experimental results presented herein show the effectiveness of the proposed strategy on an engine with test results. When the three changes listed above were implemented on the engine, the result was B100, B20, and B5 biodiesel blends which, on a cycle-averaged basis, generally produced better torque, better efficiency, better BSNOx, better BSPM, and better combustion noise than conventional diesel. Although various test results and features shown herein pertain to diesel engines, this is by way of example only.

Yet other embodiments of the present invention pertain to any internal combustion engine, including spark ignition, Wankel engines, and gas turbine engines. Further, although test results will be shown and described pertaining to the blend of a petroleum-based diesel fuel with a biofuel, it is understood that yet other embodiments of the present invention pertain to the use of any fuel in which some portion of the fuel contains an oxidizer (including but not limited to, oxygen).

The justification for the control variable based accommodation strategy is physically-based, and this type of approach is generalizable to other engine platforms. Also, the experimental results which were presented show that the behavior is generally similar across the 12 operating points with 3 blends.

The advantage of some embodiments of the proposed control variable based accommodation as compared to the experimental optimization based strategy is a practical advantage. A control variable based approach does not require the amount of experimental testing that would be required in an experimental optimization based approach. In addition, the implementation of a control variable based strategy is relatively straightforward. The development of the ECM decision-making lookup maps is one of the most difficult tasks which engine manufacturers complete. An experimental optimization based approach could require new lookup maps for different blends of biodiesel. A control variable based approach allows all of the existing ECM lookup maps to remain generally unchanged. Some embodiments of the present invention include the use of a “translation” of the existing lookup maps so that the new control variable are used. Although some specific advantages have been discussed with regards to particular embodiments of the present invention, this is by way of example only. Yet other embodiments may include other advantages, and further may not include any of the advantages just discussed herein.

One embodiment of the present invention pertains to biodiesel blend accommodation, that is, the process of changing the ECM decision-making process such that all fuel blends (from B0 to B100) are utilized as effectively as possible. An experimental study conducted at 4 steady-state operating conditions with 4 blends of soy-biodiesel.

Simultaneous modulation of 4 engine settings were examined: charge flow/air-fuel ratio, EGR fraction, rail pressure, and start of main injection. Optimization based on regression fits of the data show that modulation of these 4 engine settings can result in BSNOₓ, BSPM, and Peak dP/dt levels that are all at or below B0 levels. The optimization also improves BSFC relative to nominal ECM decision-making, however, BSFC levels are still considerably higher than nominal B0 levels. The optimization results indicate that optimal settings for biodiesel blends (relative to B0 settings) are generally characterized by: decreased air-fuel ratio, increased EGR fraction, nearly the same rail pressure, and advanced (earlier) start of main injection.

FIG. 5.1 reflects a basic overview of a method according to one embodiment of the present invention. As one example, there are two inputs to electronic control module 40: engine speed and the accelerator pedal position (interpreted as a desired torque). Based on these two inputs, the ECM 40 decision-making process 100 produces 9 outputs. These outputs are the variables which the ECM controllers then use to achieve via modulation of the engine actuators (fuel injectors, EGR valve, etc.). Note that 7 of the 9 variables are directly related to the way in which the fuel is introduced into the cylinder (3 quantity-related variables, 3 timing-related variables, and 1 pressure related variable). The other two variables, EGR fraction and charge flow, are related to the gas exchange process. Note that the combination of total fueling, charge flow, and EGR fraction implicitly dictate the air-fuel ratio (AFR).

Some embodiments to the present invention pertain to modulation of the ECM decision-making with respect to 4 of the 9 variables: charge flow, EGR fraction, rail pressure, and start of main injection. The total fueling refers to the operating condition.

Experimental results reported herein were taken on an inline 6 cylinder 2007 Cummins 6.7 liter 24-valve ISB series engine. Torque was measured via a General Electric model IG473 eddy current dynamometer. Intake air flow was measured volumetrically via a Meriam Model 50MC2-4F laminar flow element. Fuel flow was measured volumetrically via an Omega FPD1000B Series oval gear type positive displacement flowmeter. In-cylinder pressure was measured with a piezoelectric Kistler Model 607C pressure transducer placed in cylinder #4 (fourth cylinder from the vibration damper end of the crankshaft). High-resolution (50 kHz) CAD data was taken using the stock crankshaft and camshaft encoders (6 CAD resolution) and then assuming constant speed over the 6 CAD intervals between crankshaft encoder teeth. O₂ levels in both the exhaust as well as the intake manifold were measured using Bosch commercial-grade wideband O₂ sensors. CO₂ levels in both the exhaust as well as the intake manifold were measured via a Cambustion NDIR500 CO/CO₂ 2-channel fast response analyzer. NOx levels in the exhaust were measured with a Cambustion fNOx400 CLD 2-channel fast analyzer. Particulate matter (PM) levels were measured with a photoacoustic AVL 483 Microsoot Sensor. Four soy-based biodiesel blends were tested: B0, B5, B20, and B100. These fuels were blended by British Petroleum (BP). The B0 stock was designed to have fuel properties consistent with 2007 emissions certification fuel. It is understood that the foregoing description of the experimental setup is by way of example only and not limiting on any embodiment of the present inventions.

This experimental study examined 4 operating conditions. These operating conditions are defined by engine speed and total fueling and are displayed on the torque curve diagram shown in FIG. 5.2. Note that the torque values shown correspond to B0 fuel with the nominal ECM decision making. These locations are referred to as A25, A100, B50, and C100. This nomenclature comes from the Supplemental Emissions Test (SET) Cycle. The letters A, B, and C correspond to the speeds 1576, 1944, and 2311 rpm, respectively. The numbers 25, 50, and 100 designate the percent load (on the 280 hp torque curve). While the engine is rated at 325 hp engine, the 280 hp torque curve was used to avoid hardware limitations due to certain physical constraints. Also note that FIG. 5.2 displays the Not-To-Exceed (NTE) region where emissions are tightly regulated by the Environmental Protection Agency (EPA).

TABLE 5.1
Constant and Varied Settings.

CONSTANT SETTINGS
Total Fueling Quantity
Pilot Fueling Quantity
Post Fueling Quantity
Pilot-to-Main fuel Injection Separation
Main-to-Post Fuel Injection Separation
Intake Manifold Temperature
VARIED SETTINGS
Charge Flow
EGR Fraction
Fuel Rail Pressure
Start of Main Fuel Injection

Table 5.1 displays the settings which were held constant and the 4 settings which were varied at each of the 4 operating conditions with each of the 4 fuel blends. At each location and with each blend, experiments were performed with at least 150 random different combinations of the 4 varied settings.

All fueling parameters except total fueling were controlled via the existing open-loop ECM control. Total fueling was closed-loop controlled based on the fuel flow rate from the lab-grade positive-displacement flow meter. EGR fraction was closed-loop controlled based on the measured CO₂ and O₂ levels in the exhaust and intake manifold. Charge flow was closed-loop controlled based on the aforementioned EGR fraction measurements as well as the fresh air flow measurements from the laminar flow element. Rail pressure was closed-loop controlled by the normal ECM decision making process. Intake manifold temperature was regulated by manual control of the cooling water flow through the charge air cooler.

FIG. 5.3 shows the engine performance with B100 soy-based biodiesel relative to B0 performance if the ECM decision-making is unchanged from the nominal stock B0 settings. Brake specific fuel consumption (BSFC) increases between 11% and 20%. Brake specific nitrogen oxides (BSNOx) increase between 4% and 39%. Brake specific particulate matter (BSPM) decreases between 82% and 91%. The peak rate of change of in-cylinder pressure (Peak dP/dt), a metric for combustion-related acoustical noise ranges from a 13% decrease at A25 to a 13% increase at C100.

FIGS. 5.4 and 5.5 display the nominal performance for B20, and B5 fuel blends, respectively. In general, the trends are similar to those observed with B100 fuel: increased BSFC and BSNOₓ, decreased BSPM, and nearly the same Peak dP/dt. One notable exception is the decreases in BSFC and BSNOₓ, which were observed at the A25 location with both B20 and B5 fuel.

In some embodiments of the present invention the optimization problem is characterized by the following expressions:
minimize:

BSFC=function (AFR, EGR, RP, SOI)
subject to:

BSNOₓ=function (AFR, EGR, RP, SOI)<(BSNOₓ)_{B0,nominal}

BSPM=function (AFR, EGR, RP, SOI)<(BSPM)_{B0,nominal}

Peak dP/dt=function (AFR, EGR, RP, SOI)<(Peak dP/dt)_{B0,nominal} (5.1)

These state that, at any given operating condition with any given fuel, the optimal settings for air-fuel ratio (AFR), EGR fraction (EGR), rail pressure (RP), and start of main injection (SOI) will produce the lowest possible BSFC without exceeding the nominal B0 levels of BSNOₓ, BSPM, and Peak dP/dt (i.e., no increase in emissions or noise). In optimization terminology, BSFC is the cost function, while BSNOₓ, BSPM, and Peak dP/dt are 3 inequality constraints. It is understood that the parameters of an optimization process can be established in different ways, and that the foregoing description is only one example of an optimization process.

Discrete data points were used to generate continuous functions which describe the empirical relationships between the engine inputs (AFR, EGR, RP, and SOI) and the engine outputs (BSFC, BSNOₓ, BSPM, and Peak dP/dt). For each output, the regression fit utilizes a second-order function with all cross-terms. The following is an example of the form of the resulting functions:

BSFC=k₁·AFC+k₂·EGR+k₃·RP+k₄·SOI+k₅·AFR²+ . . . +k₃₁·SOI·EGR²+k₃₂·SOI·RP²+k₃₃ (5.2)

where k₁, k₂, k₃, . . . are the constant coefficients.

The regression fit used the method of least-squares to find coefficients for each of the 33 terms. The regression fitting process produced a total of 64 functions: 4 outputs at 4 operating locations with 4 fuel blends.

The regression fits allow for the optimal settings of (AFR, EGR, RP, and SOI) to be determined via application of Eq. (5.1). This was done by sampling the regression fits across the experimental ranges of all 4 settings. This method included global optima, and not just local optima. Table 5.3 displays the nominal engine settings at the 4 operating conditions, while Table 5.4 displays the optimal settings for B100 as identified by utilization of the regression fits.

TABLE 5.3
Nominal engine settings at the 4 operating conditions.

| Variable | Units | A25 | A100 | B50 | C100 |
|---|---|---|---|---|---|
| air-fuel ratio | None | 39.2 | 20.3 | 26.3 | 22.0 |
| EGR fraction | % | 11.8 | 7.3 | 20.1 | 16.5 |
| rail pressure | bar | 1299 | 1083 | 1497 | 1765 |
| start of main injection | DBTDC | 0.73 | 1.38 | 0.87 | 6.75 |

TABLE 5.4
B100 optimal engine settings at the 4 operating conditions.

| Variable | Units | A25 | A100 | B50 | C100 |
|---|---|---|---|---|---|
| air-fuel ratio | None | 33.7 | 19.5 | 24.1 | 21.5 |
| EGR fraction | % | 16.3 | 15.6 | 23.7 | 26.1 |
| rail pressure | bar | 1261 | 1168 | 1380 | 1799 |
| start of main injection | DBTDC | 4.46 | 6.50 | 5.17 | 6.58 |

Comparison of Table 5.3 with Table 5.4 shows how the optimal engine settings for B100 differ from the nominal engine settings. Note that at various operating conditions the optimal B100 AFR is lower, and the optimal EGR fraction is higher. The optimal B100 rail pressure is generally close to the nominal setting. The optimal B100 start of main injection is earlier (advanced) relative to the nominal settings, except for the C100 operating condition where there is little difference. Note is that the combination of decreased AFR and increased EGR fraction results in optimal charge flows for B100 that are near those for B0. The trends observed in the optimal settings with B100 fuel were generally observed with B20 and B5 blends as well.

Nominal and optimal engine performance for B5, B20, and B100 were determined at 4 operating locations. In many cases, it was possible to satisfy the BSNOₓ, BSPM, and Peak dP/dt constraints. The optimal settings generally improve BSFC relative to the nominal settings, however, the optimal settings are generally unable to improve BSFC levels relative to B0. This is primarily attributable to the lower energy content of biodiesel blends (−12.8%, −2.6%, and −0.6% for B100, B20, and B5 respectively).

Control systems according to some embodiments to the present invention involve replacement of certain control variables with new control variables. For some engines, the ECM decision-making process (depicted in FIG. 5.1) has two inputs: engine speed and accelerator pedal position. There are also nine outputs: 1) total fueling, 2) pilot fueling, 3) post fueling, 4) start of main injection, 5) pilot-to-main injection separation, 6) main-to-post injection separation, 7) fuel rail pressure, 8) charge flow, and 9) EGR fraction. These 9 control variables characterize the engine settings, however, these are not unique, and other embodiments of the present invention contemplate the use of different inputs and different outputs. However, in yet other embodiments, It is possible to use other control variables instead of these particular 9. In some embodiments, 3 control variables are replaced, including replacement of EGR fraction with combustible oxygen mass fraction (COMF); replacement of total injected fuel mass with total injected fuel energy; and replacement of start of main injection (SOMI) with end of main injection (EOMI). It is understood that some embodiments of the present invention may include only one or two of the preceding three control variables, in any combination.

Various experimental results reported herein indicated that optimal EGR fractions for biodiesel blends can be higher that the optimal EGR fractions for B0. An explanation for this phenomenon can be found by examining the basics of EGR technology. The purpose of EGR is principally to reduce NOₓ, emissions. The formation of NOₓ, is exponentially dependent upon temperature and studies have shown that the main reason that EGR reduces NOₓ, is that EGR dilutes the charge, which reduces the oxygen fraction in the charge. Reduced oxygen fraction reduces flame temperature in a diffusion type flame because, although the same amount of oxygen is present at the flame to oxidize the fuel, a larger quantity of inert species (e.g. N₂, CO₂, H₂O, etc.) are also present and these inert species absorb the heat of combustion. It should be noted that there are other reasons why EGR reduces temperature and NO, other than reduction of oxygen fraction (such as the thermal effects of adding species such as CO₂ and H₂O which have relatively high heat capacities), however the reduction in the oxygen fraction is generally considered to be one factor. It has been shown that there is an approximately linear relationship between oxygen fraction and stoichiometric adiabatic flame temperature, and there is also an exponential relationship between temperature and NOx. This is the reason that the relationship between oxygen fraction and NOx is generally observed to be exponential.

Traditionally, oxygen fractions have been characterized by the fraction of O₂ in the intake charge. This definition is altered slightly, for dealing with an oxygenated fuel such as biodiesel. Some embodiments of the present invention utilize the combustible oxygen mass fraction (COMF) defined as follows:

$$COMF = \frac{{Y}_{{O}_{2 , air}} {\dot{m}}_{air} + {Y}_{{O}_{2 , exhaust}} {\dot{m}}_{ECR} + {Y}_{{O}_{, fuel}} {\dot{m}}_{fuel}}{{\dot{m}}_{air} + {\dot{m}}_{EGR} + {\dot{m}}_{fuel}} \qquad ( 6.1 )$$

Y represents mass fraction and Mdot represents mass flow rates. This definition takes into account the oxygen atoms contained in the oxygenated fuel molecules.

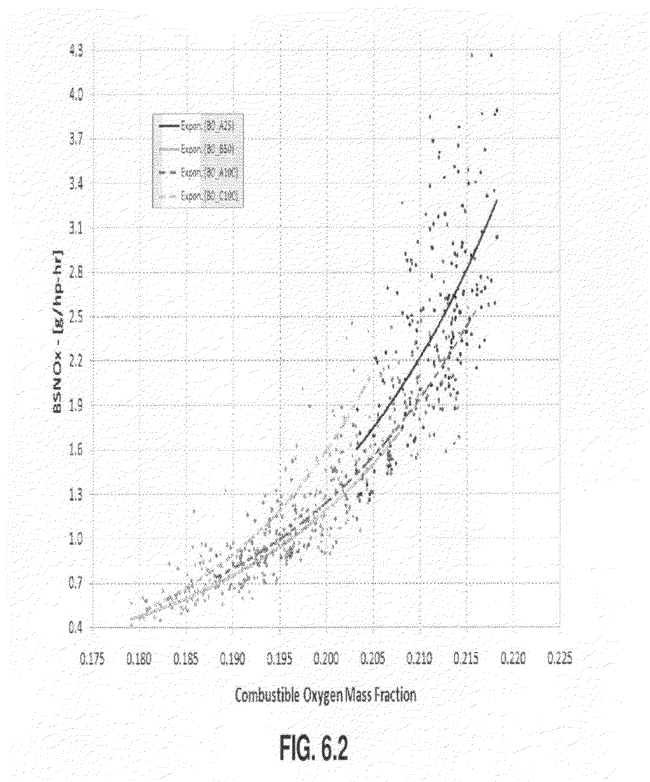

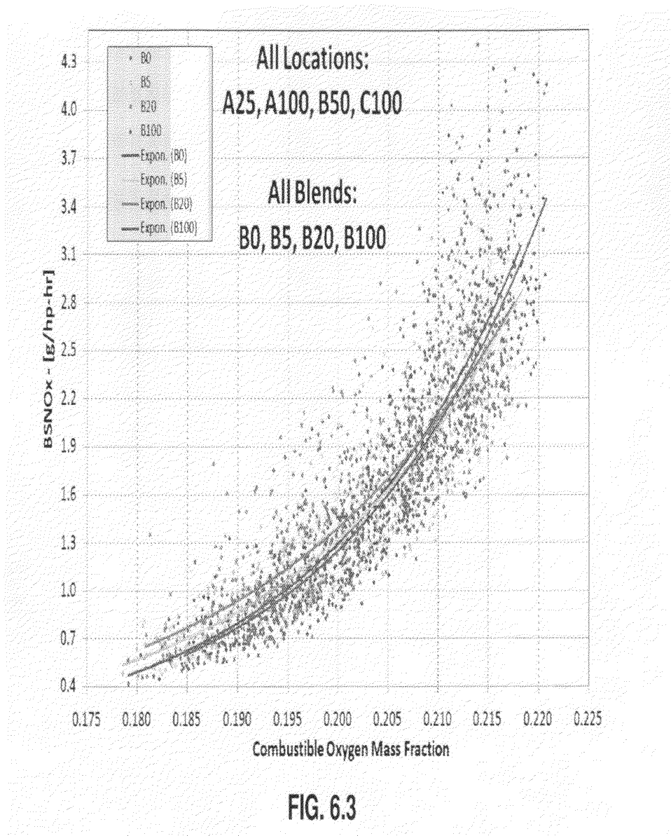

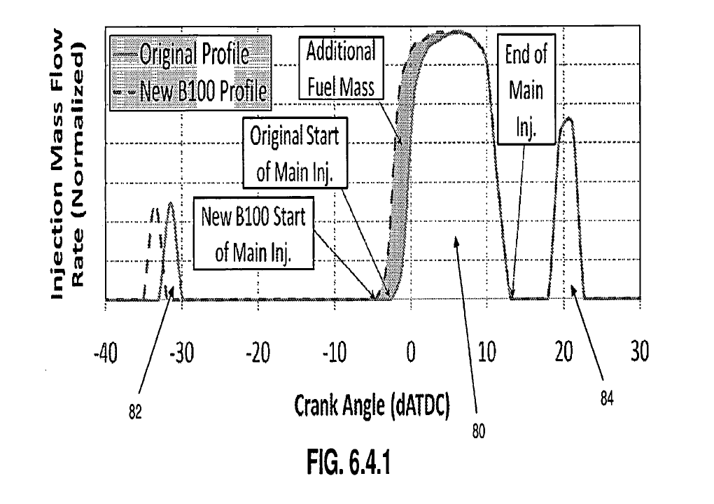

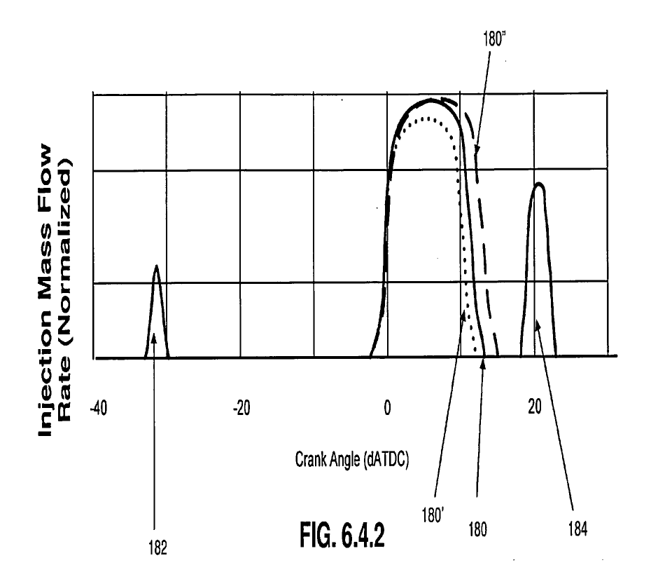

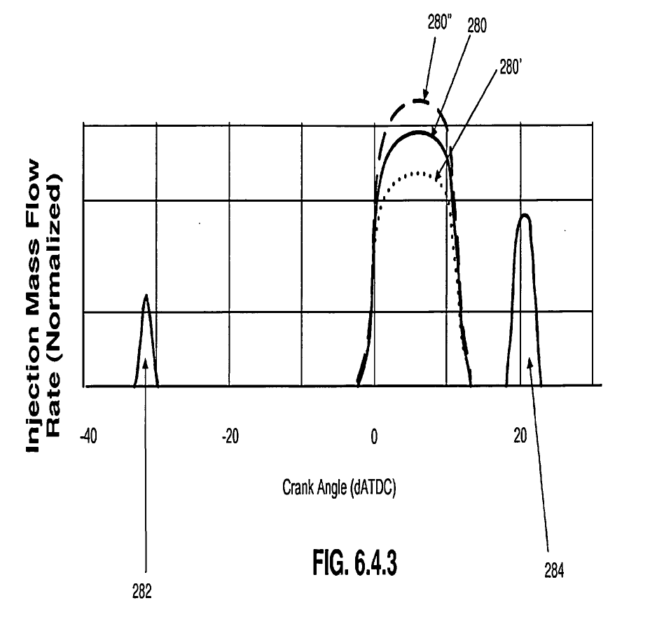

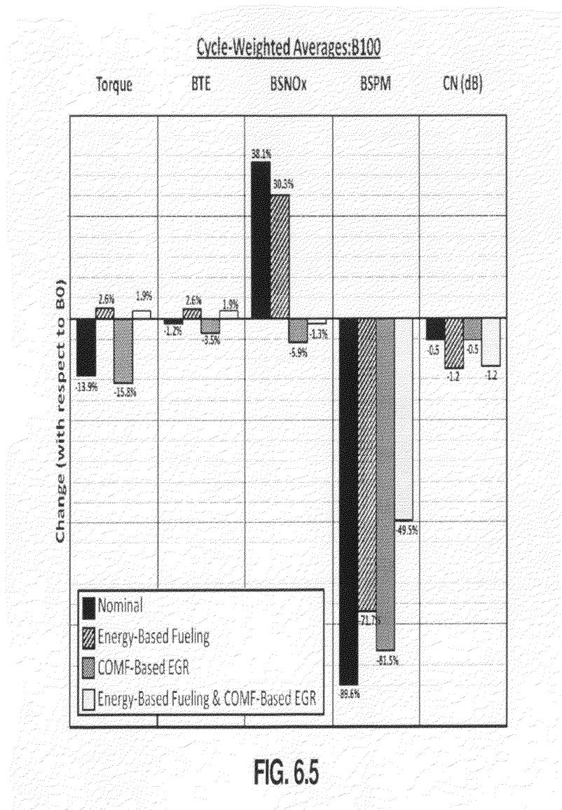

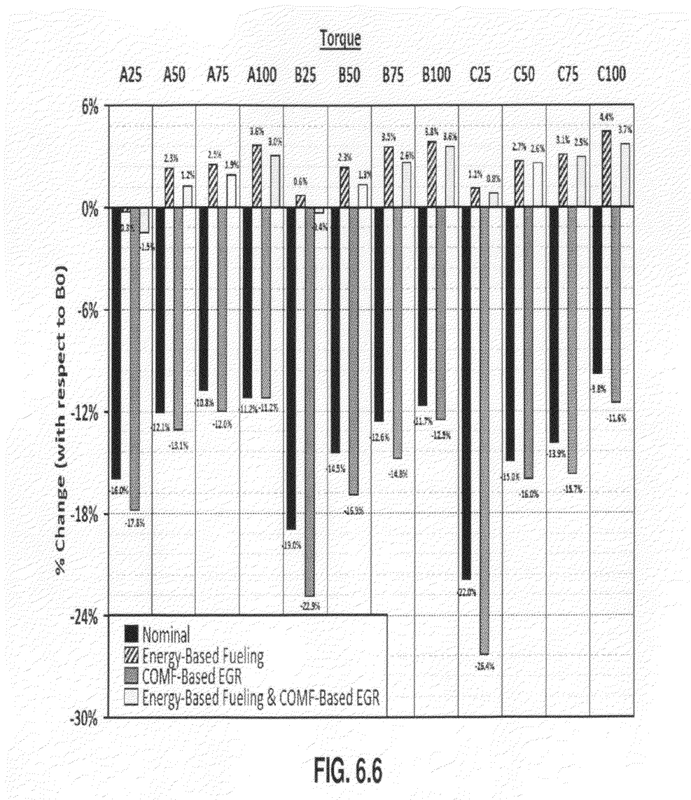

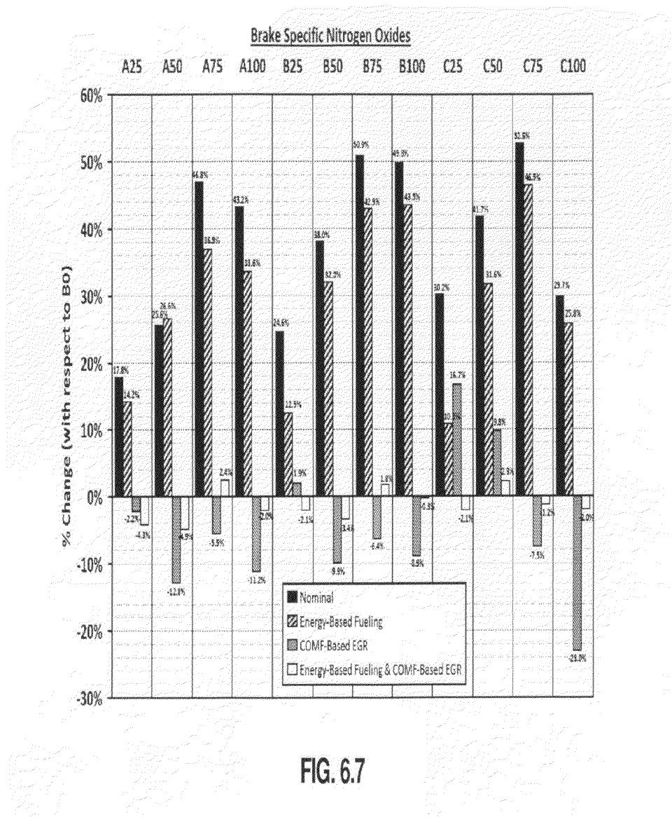

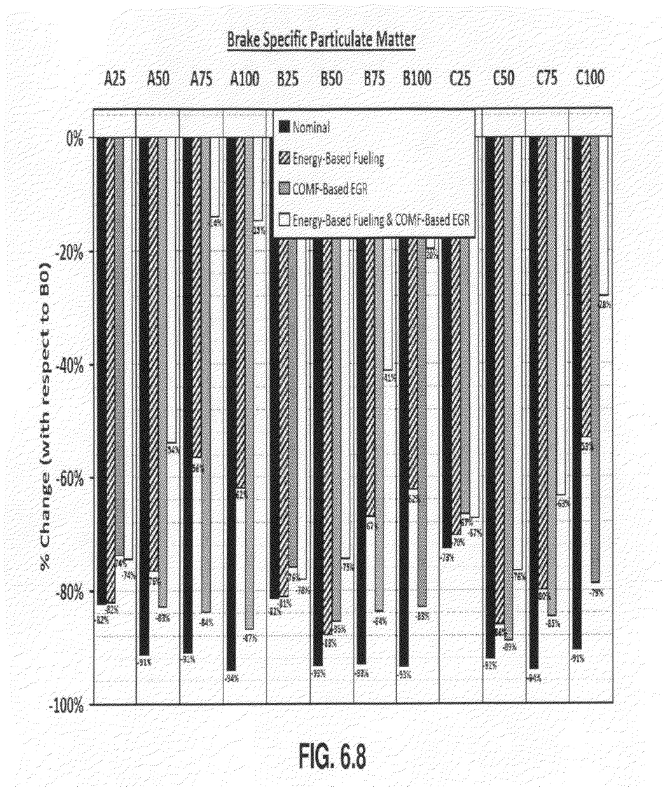

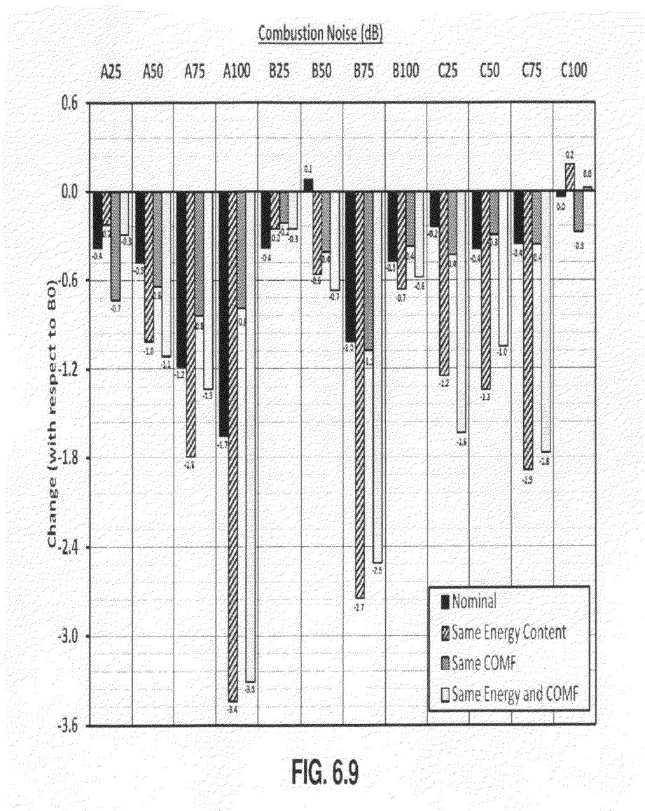

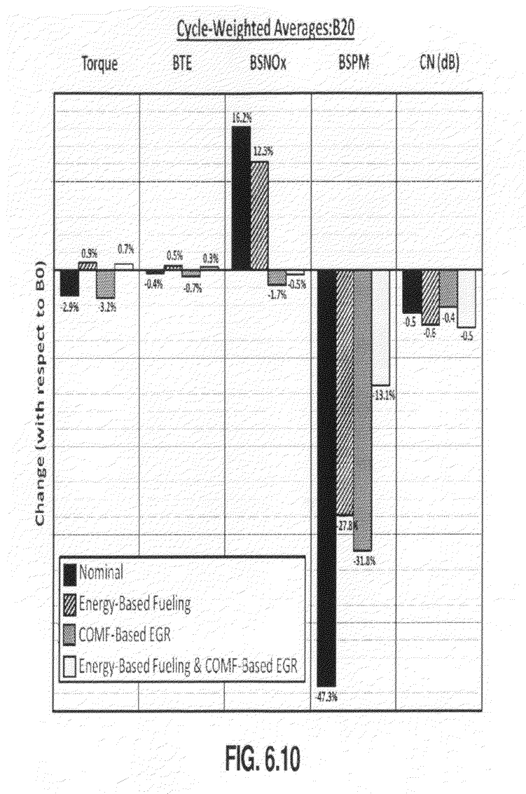

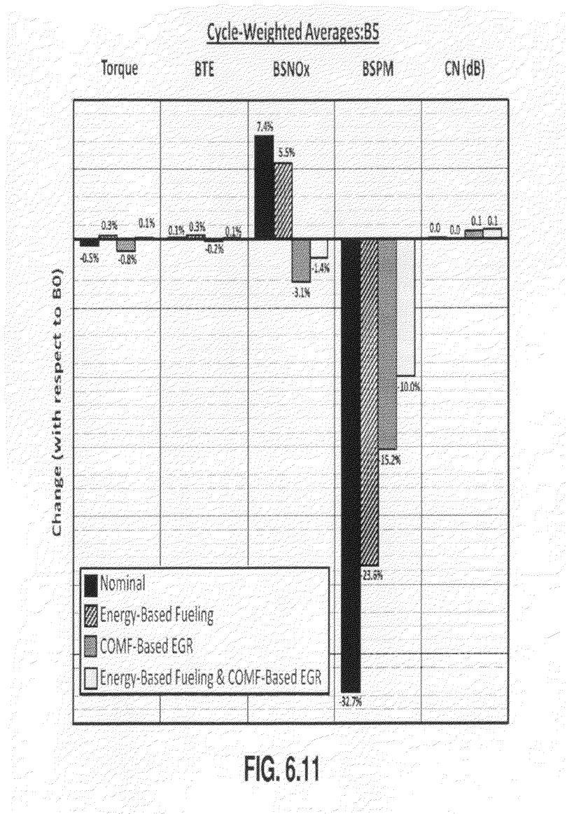

FIG. 6.3 suggests that this relationship between COMF and BSNOₓ may in fact be somewhat invariant to the biodiesel blend fraction. This suggests that if blends of biodiesel are combusted with the same COMF, the same BSNOₓ will likely result (provided the other inputs to the combustion process are unchanged as well).

Note that if EGR is used as the control variable, COMF is higher for blends of biodiesel. This is for two reasons. First, the oxygenated biodiesel blends contribute oxygen directly from the fuel. Secondly, a greater fraction of O₂ is present in the EGR gases. This is because the mole fraction of O₂ in the exhaust is greater for biodiesel blends combusted at the same air-fuel ratio

Because biodiesel blends are less energy-dense than conventional diesel fuel, the maximum torque/power that an engine can produce is lower when the conventional engine control strategy is used. This is because at any given speed some engine control algorithms have a fueling limit, which dictates the maximum amount of total fueling which can be sent to the engine. Some embodiments of the present invention control the total fueling on an energy basis rather than a mass basis. This is straightforward, since the energy content of the fuel can be calculated if an estimate of the biodiesel blend fraction is available. The new total injected fuel mass, TF_{new}, required to provide the same total injected fuel energy is defined by the following equation:

$$T {F}_{new} = \frac{{E}_{D}}{{E}_{D} + B ( {E}_{BD} - {E}_{D} )} {TF}_{old} \qquad ( 6.2 )$$

E_{D} and E_{BD} represent the energy content of diesel and biodiesel, respectively. B represents the biodiesel blend fraction and TFotd represents the original injected fuel mass.

Two inputs to some ECM decision-making processes are engine speed and the accelerator pedal position. The accelerator pedal position is essentially equivalent to a desired torque level. With the conventional engine control structure the vehicle operator depresses the accelerator pedal further when using biodiesel blends because more total fueling is required to achieve the same torque output. With a control structure according to one embodiment of the present invention of using total injected fuel energy, the same pedal position should result in approximately the same torque output (assuming approximately the same engine efficiency).

The replacement of total injected fuel mass with total injected fuel energy, implies that biodiesel blends have additional fuel injected. Therefore some embodiments of the present invention pertain to various changes in the fuel injection profile There are several possible ways to add this additional fuel: increase the rail pressure; move the start of the main injection pulse earlier; move the end of the injection pulse later; or some combination of above. It is understood that the foregoing are presented as examples only, and are not construed to be limiting. For example, in yet other embodiments, the additional fuel mass is injected at a time other than during the main fuel injection pulse.

Some embodiments of the present invention pertain to advancing the start of the main fuel injection pulse (SOMI). Yet other embodiments pertain to both advancing the start of the main pulse, and also delaying the end of the main pulse. Further embodiments pertain to control of the end of the main fuel injection pulse (EOMI). FIG. 6.4.1 shows the use of EOMI as the control variable in place of SOMI. An example of the result of these changes can be seen in FIG. 6.4.1.

FIG. 6.4.1 shows a plurality of fuel pulses being provided to a cylinder 22 by an injector 78 according to one embodiment of the present invention. Note that the timing of the pulses are expressed in terms of the engine operating cycle, and not time. As shown in FIG. 6.4.1, a notation of 0 (zero) degrees crank angle refers to the crank angle after top dead center (ATDC), which is commonly assigned to the position of maximum geometric compression within the cylinder proximate to the start of combustion. FIG. 6.4.1 shows a first “original” profile with a solid line. This profile pertains to the timing of the main, pilot, and post fuel pulses (80, 82, and 84, respectively) for a first blend of fuel. The dotted lines then indicate a new profile in which a fuel having a higher oxygen content has been detected, and for which the software 100 is providing accommodation. Because of the additional oxygen content, and including those situations in which the fraction of EGR has been increased, it is desired to provide additional fuel of the new blend (as exemplified by B100 in FIG. 6.4.1) so as to maintain a total amount of energy provided to cylinder 22 that is substantially the same as the total amount of energy provided by the first fuel (the “original” profile in FIG. 6.4.1). It can be seen that the additional fuel (indicated by a shaded area) is injected earlier in the cycle, and as an addition to main fuel pulse 80. Note that main fuel pulse 80, whether using the first fuel or the second, higher biodiesel-content fuel, is maintained with the same timing for the end of the pulse.

It is understood that the overlay of fuel pulses shown in FIG. 6.4.1 is by way of example only, and other methods of providing additional fuel are contemplated in other embodiments. As another example, yet other embodiments contemplate changing main pulse 80 by increasing the rail pressure, yet maintaining the start of the main pulse and the end of the main pulse at substantially the same positions within the cycle. In such embodiments the main fuel pulse with the higher blend fraction has a peak fueling that is greater than the peak with the lower blend fraction. In yet other embodiments, it is contemplated to maintain the start of the main injection pulse at approximately the same moment, and instead compensate for higher blend fractions by lengthening the duration of the pulse such that the end of the main pulse shifts to a position later during the engine cycle. Further in some of these embodiments in which the end of the main pulse is extended, the post fuel pulse 80 may be likewise modified. In some embodiments this modification involves the changing of the injector command signals so that the main pulse 80 and post pulse 84 do not blend together, and maintain a separation. Examples of such modifications can be found in PCT application PCT/US10/60110, filed Dec. 13, 2010, titled FLOW RATE ESTIMATION FOR PIEZO-ELECTRIC FUEL INJECTION, Attorney Docket 17933-93431.

In some embodiments of the present invention, the detection of a change in the blend fraction results in a change to the pilot fuel pulse 82. As shown in FIG. 6.4.1, in one embodiment the detection of a higher blend fraction results in movement of the pilot fuel pulse to a position earlier in the engine cycle. However, in yet other embodiments, the detection of a higher blend fraction results in an increase in the amount of fuel provided during pulse 82, yet with substantially the same timing as for the lower blend fraction. It is further understood that in yet other embodiments, the pilot fuel pulse 82 is manipulated by a combination of the both (i.e., forward movement and an increase or decrease in the pulse peak).

Yet other embodiments of the present invention pertain to modifying the characteristics of the post fuel pulse 84 in a response to the detection of the different blend of biodiesel. In some embodiments, the start of the post pulse 84 is moved forward within the cycle as higher blend fractions are detected. In yet other embodiments the peak of the post pulse 84 is increased (such as by an increase in rail pressure) when a higher blend fraction is detected. Further, it is understood that the detection of a higher blend fraction can result in modification of any one of the pulses shown in FIG. 6.4.1, any combination of two of the pulses, or all three of the pulses. In some embodiments, the quantities of fuel provided during one or more pulses is increased in response to detecting a higher blend fraction.

FIG. 6.4.2 shows a modification to a fuel pulse according to another embodiment of the present invention. In some embodiments, the start of main injection (SOMI) is substantially fixed at a crank angle position within the engine cycle. In such cases the total fueling algorithm 120 modifies a fuel pulse by moving the end of main injection (EOMI). FIG. 6.4.2 shows a first main fuel pulse 180 which is adapted and configured to provide a quantity of energy into the engine cycle. Pulse 180′ shows a modification to this pulse, which is a result of detecting the use of a fuel having a higher energy density than the previous fuel. Pulse 180′ starts the main injection pulse at about the same crank angle, but finishes the pulse earlier in the cycle than pulse 180. Further, in some embodiments the peak of pulse 180′ is also reduced. FIG. 6.4.2 further shows a third fuel pulse 180″ in which a fuel having a lower energy density than either of the two previous fuels has been detected. In this case, the end of main injection is further delayed in terms of crank angle, in comparison to either of the two previously discussed fuels. FIG. 6.4.2 shows pilot pulse 182 and post pulse 184 remaining relatively constant as the fuel energy density changes, although this is by way of example only, and is not limiting to any particular embodiment.

FIG. 6.4.3 shows yet another method for modifying the fueling of internal combustion engine in response to a change in the energy density of the fuel being combusted. A first main fueling injection event 280 is shown adapted and configured for a fuel having a particular energy content. Pulse 280′ shows a modification to this pulse as a result of the detection of a fuel in usage that has a higher energy density. In some embodiments, both the start and end of the main injection pulse occur at about the same crank angle. The peak of the pulse is lower, indicating that a lower total amount of fuel is being injected. However, in consideration of the higher energy content of the fuel, the total energy provided to the engine is held about constant. Fuel pulse 280″ shows the response of algorithm 100 to the detection and usage of a fuel having a lower energy density than either of the two previously discussed fuels. Again, the start and end of the main injection pulse are held approximately constant; however, the peak of the pulse is increased so that more fuel (but approximately constant energy) is injected into the cylinder. In some embodiments the magnitude of the peak fueling is changed by varying fuel pressure provided by fuel rail 24.

The engine used for these experiments was the same inline 6 cylinder 2007 Cummins 6.7 liter 24-valve ISB series engine used for the experimental work presented in all the previous chapters. Torque was measured via a General Electric model IG473 eddy current dynamometer. NOx emissions in the exhaust as well as CO₂ in both the intake and exhaust were measured with California Analytical Instruments 600 Series Gas Analyzers. Particulate matter emissions were measured with a AVL model 483 Micro-Soot Sensor. O₂ in the exhaust was measured with a Bosch LSU 4.9 O₂ sensor (Bosch #0258017025). Fuel flow was measured with an Omega FPD1000B Series oval gear type positive displacement flowmeter. In-cylinder pressure measurements were taken with a Kistler model 607C pressure transducer. Fresh air flow was measured with a Meriam Model 250MC2-4F laminar flow element (LFE). Data acquisition was completed with a dSPACE system. ECM-to-dSPACE communication took place over a CAN interface. Four fuel blends were tested: B0, B5, B20 and B100. The conventional diesel stock was 2007 emissions certification diesel fuel and the biodiesel stock was a soy-based methyl ester biodiesel.

Each of the 4 blends was tested at the 12 non-idle operating points of the Heavy Duty Supplemental Emissions Test (SET) cycle [30]. The operating points are designated with the letters A, B, or C and the numbers 25, 50, 75, or 100. The letter specifies the engine speed. For the torque curve tested the speeds are: A=1576 rpm, B=1944 rpm, and C=2311 rpm. The numbers 25, 50, 75, and 100 indicate the percentage of full load at that particular speed. For example, B50 corresponds to 1944 rpm under 50% load, C100 means 2311 rpm under full load, etc. At each of the 12 operating points the biodiesel blends were tested under 4 different cases. Case 1 was the “Nominal” case where all the engine settings were maintained in accordance with a conventional engine control structure. Case 2 was the “Energy-Based Fueling” case where total injected fuel mass was replaced with total injected fuel energy and the SOMI was replaced with EOMI. Case 3 was the “COMF-Based EGR” case where COMF was used as a control variable in place of EGR fraction. Case 4 was the “Energy-Based Fueling & COMF-Based EGR” case. This represents the combination of Case 2 and Case 3. In some experimental cases, lab-grade measurements (not ECM estimates) of air flow, fuel flow, EGR fraction, etc. were used. ECM commands were overridden to achieve the desired actual values using a CAN-based communication protocol. The combustion noise was calculated from in-cylinder pressure measurements.

FIG. 6.5 displays the cycle-weighted average results of the 4 cases with B100 fuel. The cycle-weighted average results were computed from the 12 individual operating points using emissions weighting factors for the SET test cycle (excluding idle).

In the “Nominal” case torque was 13.9% lower than B0. This is largely attributable to the 12.8% lower energy content of B100. The “Energy-Based Fueling” case resulted in torque that was 2.6% higher than B0. This indicates that the brake thermal efficiency has actually increased, not only with respect to the B100 “Nominal” case, but also with respect to B0. This increase in efficiency is attributed primarily to the fact that the start of main injection has been slightly advanced (because additional fuel was added and EOMI was kept constant). The “COMF-Based EGR” case exhibited torque that was slightly lower than the “Nominal” case. This may be due to the increased EGR causing a decrease in efficiency. The combined case displayed torque and efficiency that were slightly better than B0. This demonstrates that some embodiments of the present invention include a proposed accommodation strategy that allows the engine to retain or even slightly increase its torque/power capacity. The torque results for B100 at each of the 12 individual operating points are generally quite similar, as can be seen in FIG. 6.6.

The increases in torque exhibited by the “Energy-Based Fueling” and the combined case are generally more pronounced at the higher load points. For example, the combined case shows torque increases over 3% at A100, B100, and C100, but A25, B25, and C25 have values of −1.5%, −0.5%, and 0.8%, respectively. At higher load points, the amount of extra fuel mass to match the fuel energy is greater than at the lower load points. Therefore the SOMI is advanced a greater amount than at lower load points. For example, at A100 the original total injected fuel mass was 115.6 mg/stroke. For pure biodiesel, 132.6 mg/stroke was used to inject the same amount of total injected fuel energy. Injecting the additional 17 mg/stroke while maintaining the same EOMI includes having the SOMI be advanced 3.75 crank angle degrees (CAD). Contrast that case with the A25 operating point where the original injected fuel mass is 31.0 mg/stroke, so only an additional 5 mg/stroke of fuel is added. This includes having SOMI be advanced by 0.5 CAD.

The “Nominal” case, which is representative of the conventional control structure, exhibited BSNOₓ emissions which were, on average, 38.1% higher than B0 levels. The “Energy-Based Fueling” case showed BSNOₓ that was lower than the “Nominal” case, but still 30.3% higher than B0. The BSNOₓ reduction (relative to the “Nominal” case) can be attributed to two factors. First, the “Energy-Based Fueling” case exhibited higher torque, therefore work output has increased. Because BSNOₓ is defined as NOₓ per unit of work output, the increased torque will cause the BSNOₓ value to be smaller. Secondly, the air-fuel ratio in the “Energy-Based Fueling” case is lower than the “Nominal” case because fuel flow has increased while air flow has remained the same. The lower air-fuel ratio results in lower O₂ levels in the exhaust (as was discussed in the blend estimation related chapters). By examination of Eq. 6.1 in can be seen that this results in lowered COMF because Y_{O2,exhaust} is smaller. Lower COMF tends to result in lower BSNOₓ.

The “COMF-Based EGR” case in FIG. 6.5 shows that replacing the control variable EGR fraction with COMF results in B100 BSNOₓ that are actually 5.9% lower than B0 levels. The combined case, the “Energy-Based Fueling & COMF-Based EGR” case exhibited BSNOₓ values that were slightly increased relative to the “COMF-Based EGR” case; however, the BSNOₓ levels are still lower than the B0 levels. Not only has the “Energy-Based Fueling & COMF-Based EGR” case resulted in torque and efficiency that are better than B0 levels, but also BSNOₓ levels which are better than B0. The BSNOx results for B100 at each of the 12 individual operating points are generally quite similar, as can be seen in FIG. 6.7. Some of the cases exhibited brake specific particulate matter (BSPM) that was lower than B0 levels, as can be seen in FIGS. 6.5 and 6.8. The “Nominal” case exhibited BSPM levels that were over 90% lower than B0 levels. It is understood that the foregoing explanation pertains to some embodiments of the present invention, but is not to be construed as limiting to all embodiments or to any single embodiment. Yet other embodiments of the present invention contemplate modifications to the EGR control schedules and/or fuel injection schedules based on detection of a change in the fuel blend fraction. In some embodiments, the detection of a higher blend fraction results in generally increased recirculation of exhaust gas. In yet other embodiments, detection of a higher blend fraction results in a general increase in the total amount of fuel injected during the engine cycle.

FIGS. 6.5 and 6.9 show that, in 4 cases the combustion noise (CN) has decreased relative to B0. Note that, while other outputs were presented in terms of relative difference (% increase or decrease), CN differences are presented in terms of the absolute difference in decibels (dB). FIGS. 6.10 and 6.11 show the cycle-averaged results for the same cases with B20 and B5 blends. The results are similar to what was seen with B100. It can be seen that the results are generally comparable for many operating points and blends.

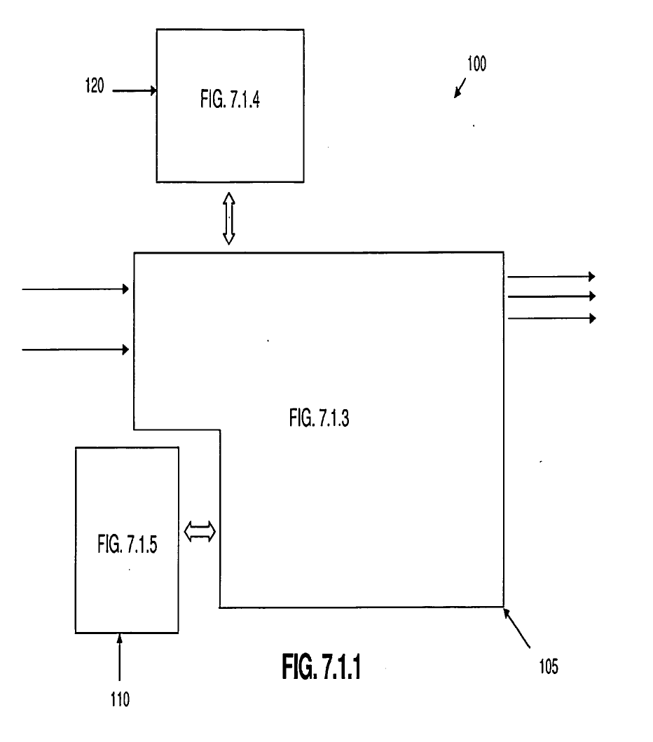

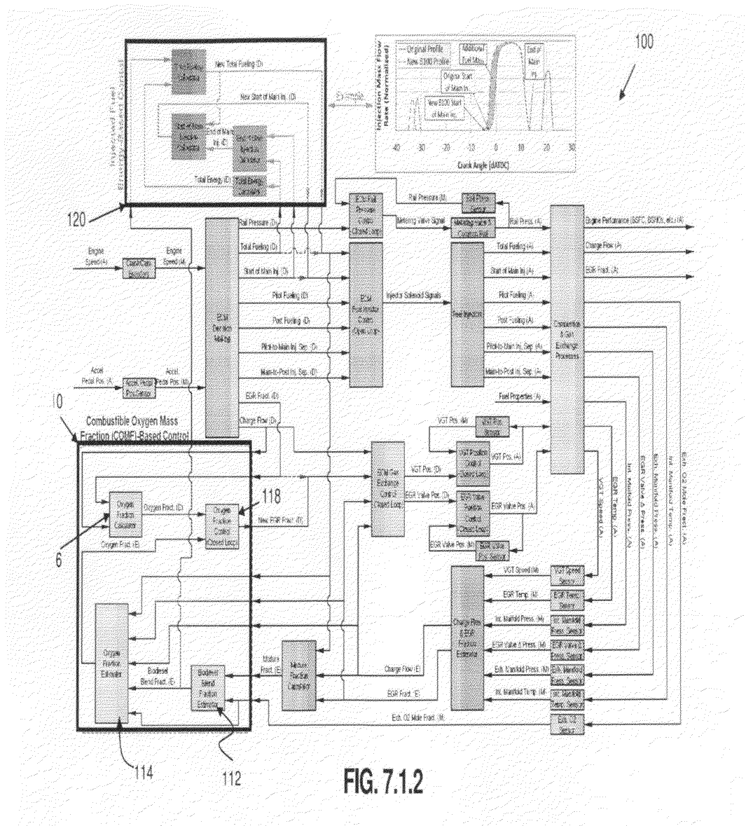

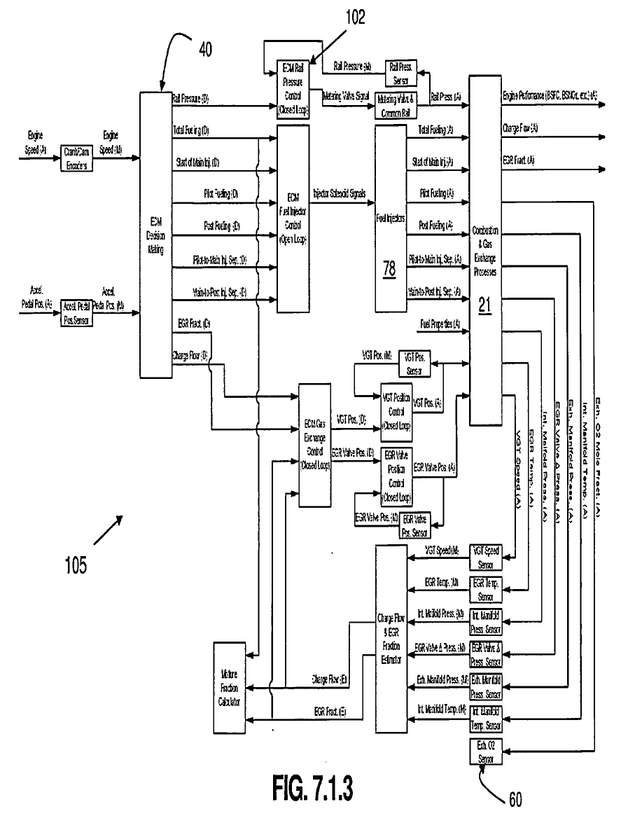

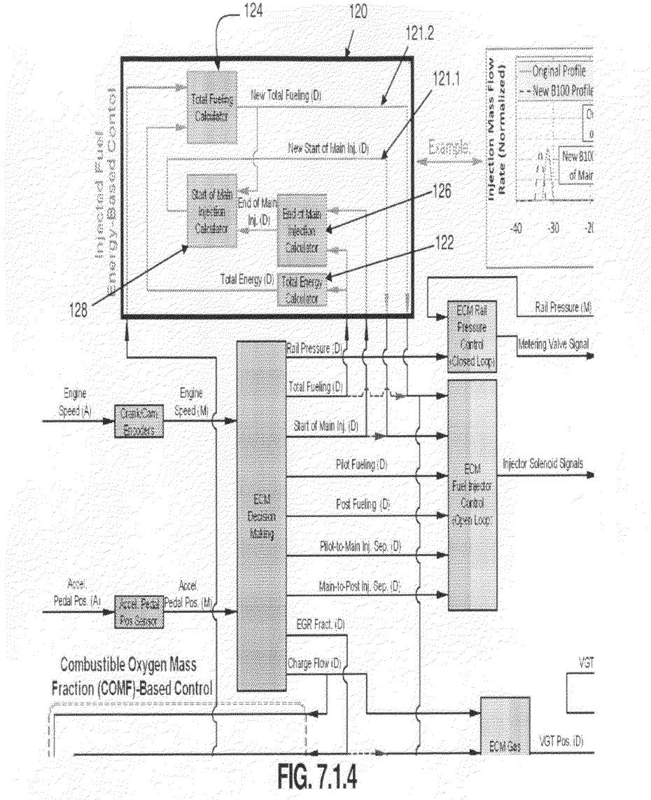

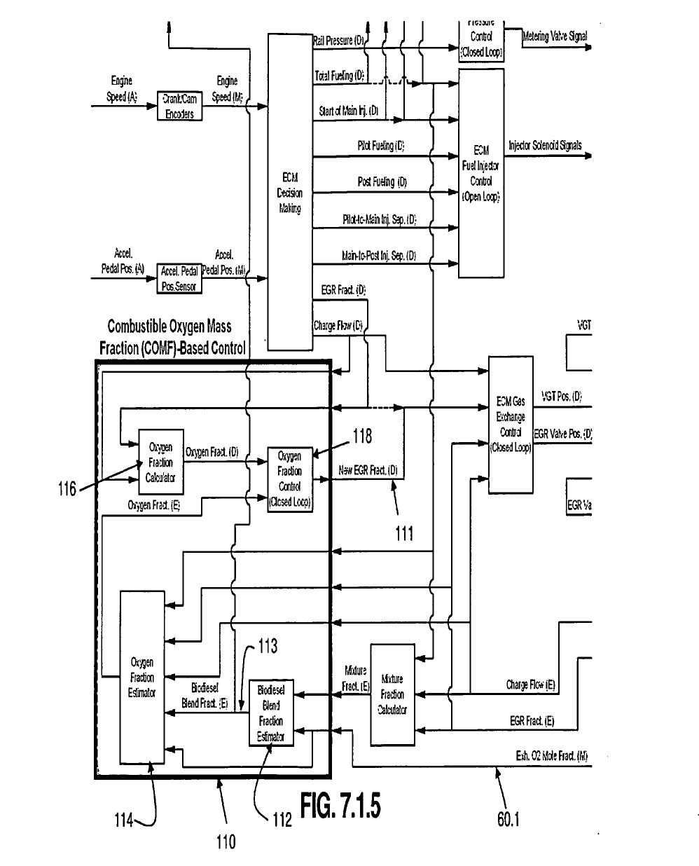

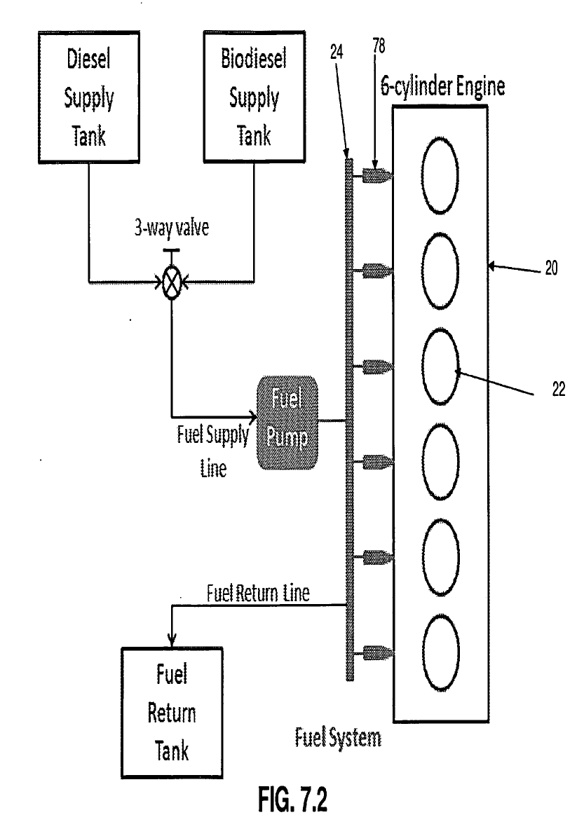

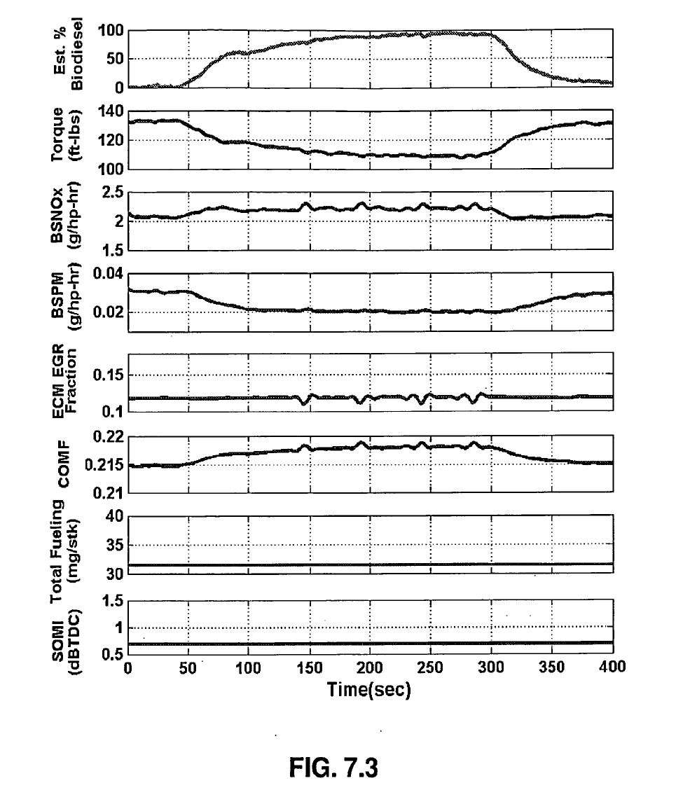

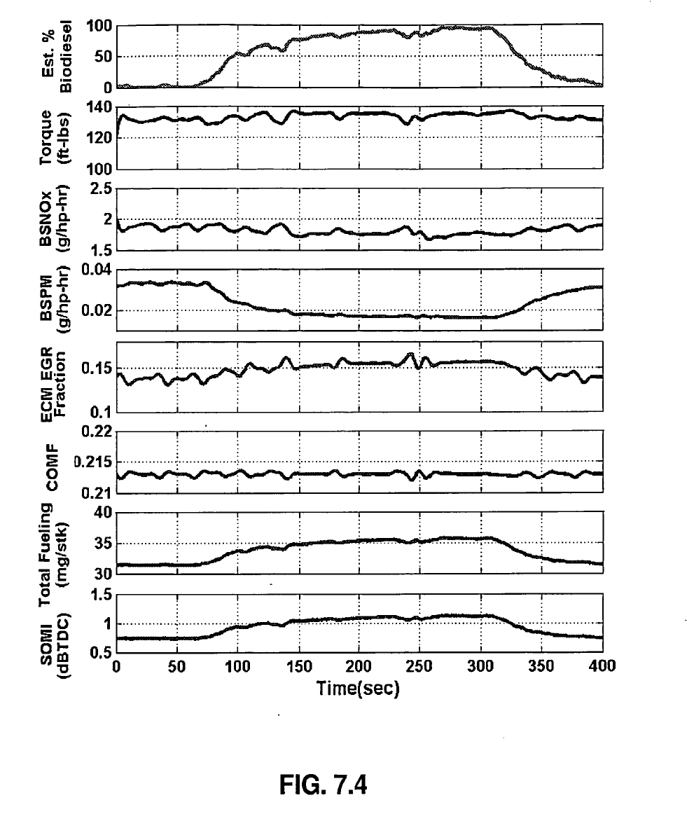

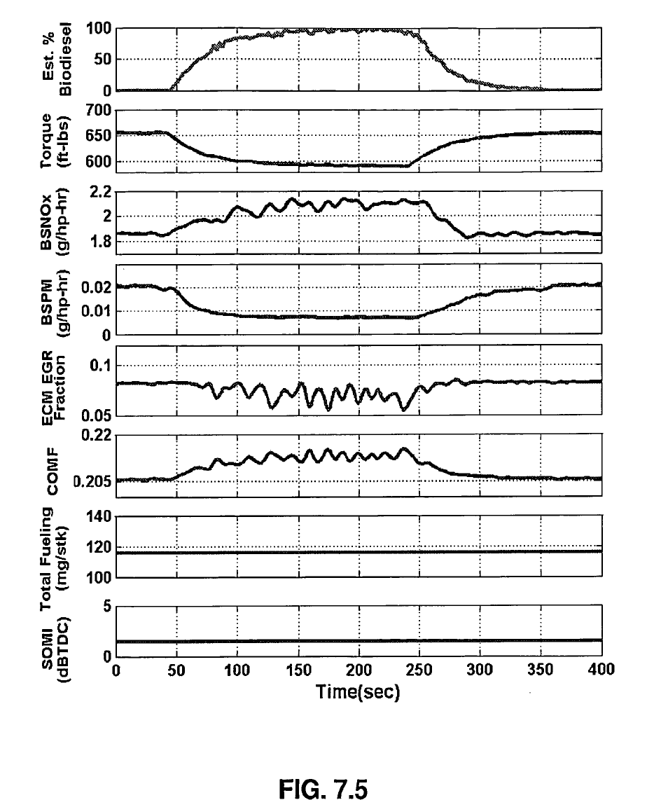

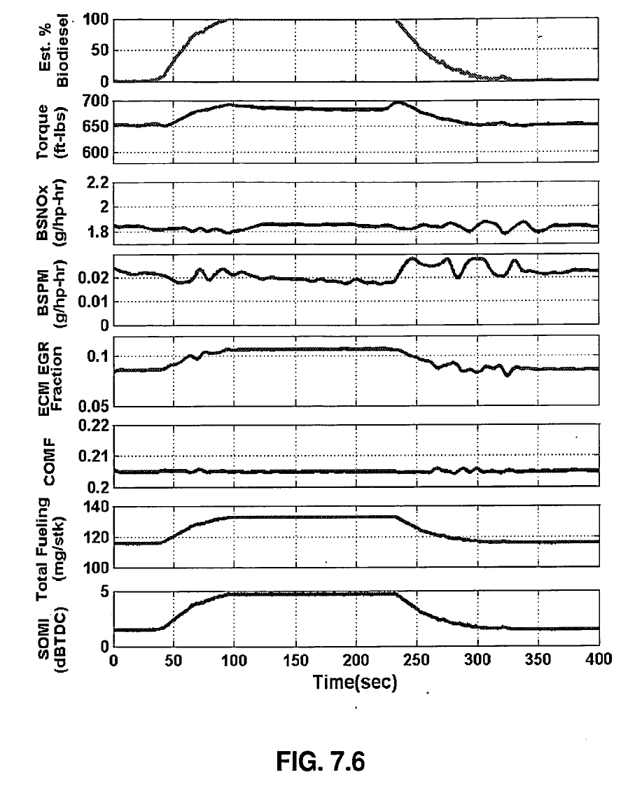

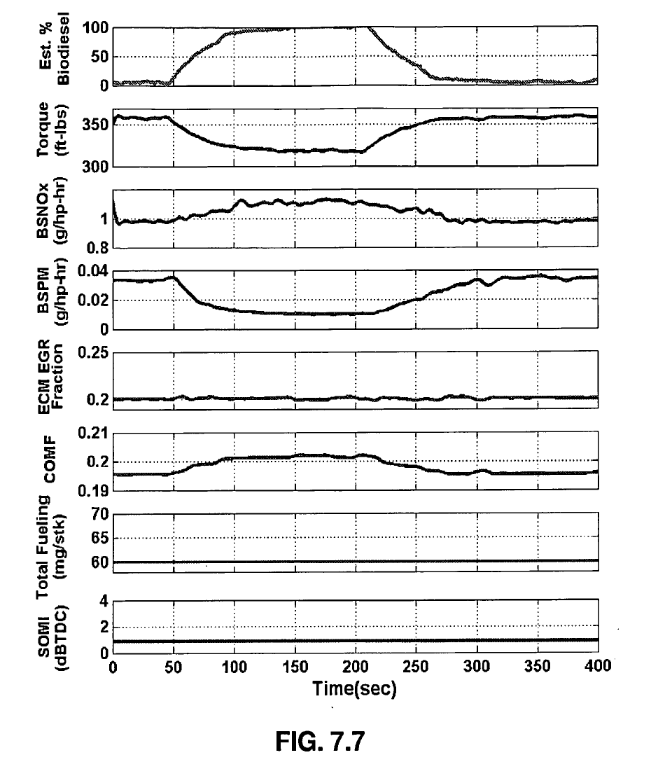

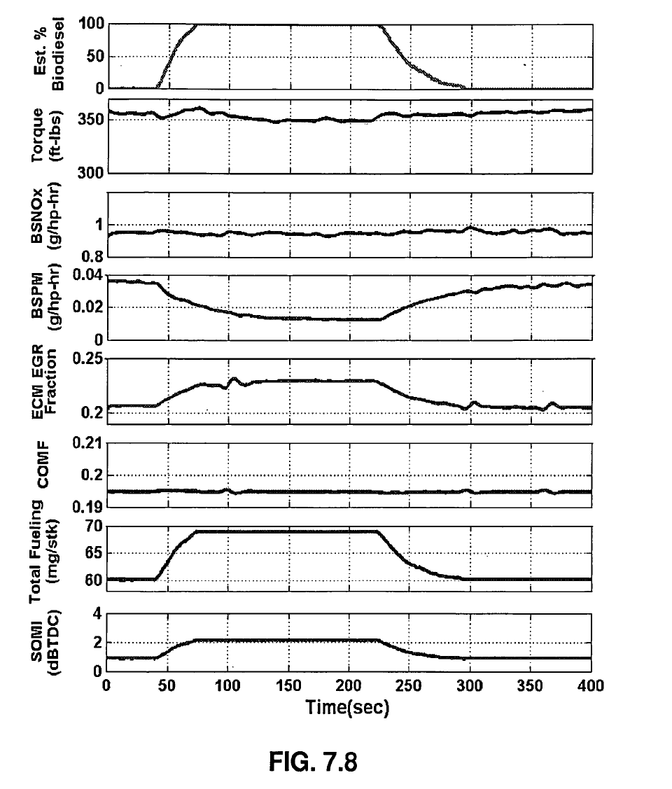

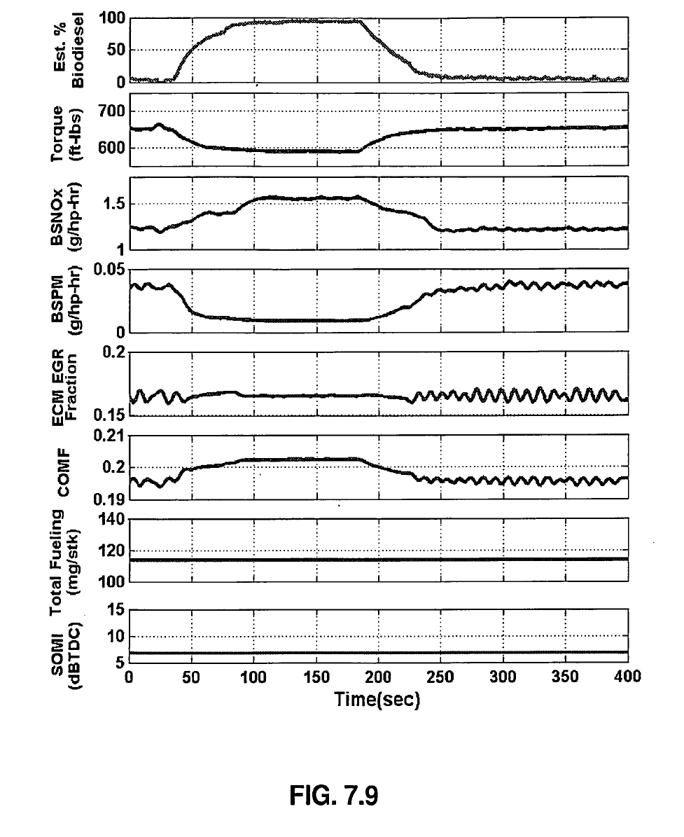

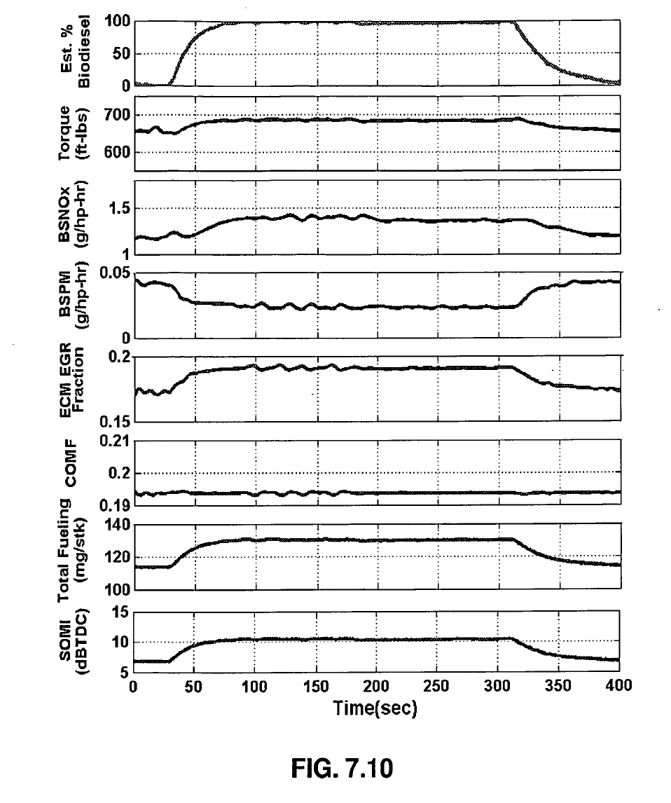

One embodiment of the present invention includes an engine control system as represented by the block diagram in FIGS. 7.1.1, 7.1.2, 7.1.3, 7.1.4 and 7.1.5. The diagrams show not only the existing control structure, but also additional functionality to estimate the biodiesel blend and then accommodate the blend via a change of control variables. It is understood that such a blend of existing and new control structures is one approach. Yet other embodiments of the present invention pertain to engine control structures in which the estimation of biodiesel blend and accommodation (such as by COMF, and/or total energy fueling) is used in new control structures.

The engine control structure 100 according to one embodiment of the present invention is shown in FIG. 7.1. The algorithms 110 represent the blend estimator and the additional blocks, respectively, required to replace the control variable EGR fraction with the control variable COMF. The algorithm 120 shows the additional functionality that makes the fueling related changes (replacing total injected fuel mass with total injected fuel energy and replacing SOMI with EOMI). Various broad, two sided arrows represent paths that exist in the conventional control structure but may not exist in the new control structure. Variable names which end with (A), (M), (D), and (E) represent values which are Actual, Measured, Desired, and Estimated, respectively.

FIG. 7.1.1 represents a higher level schematic representation of the algorithms shown in other figures. FIG. 7.1.2 shows in more detail the various components and decision blocks removed from FIG. 7.1.1 for sake of clarity. FIG. 7.1.3 represents some of the detailed components and functions represented within block 105 of FIG. 7.1.1 (and as also shown incorporated with other inventive algorithms in FIG. 7.1.2). FIG. 7.1.4 shows some of the more specific algorithms within total energy algorithm 120, along with various computational interfaces with other portions of the overall control algorithm. FIG. 7.1.5 shows some of the more specific algorithms within COMF algorithm 110 of FIG. 7.1.5, along with various computational interfaces with other portions of the overall control algorithm.

Discussion will now be given with regards to algorithms according to various embodiments of the present invention as depicted in FIGS. 7.1.1., 7.1.2, 7.1.3, 7.1.4, and 7.1.5. It is understood that these descriptions and depictions are by way of example only, and various other embodiments of the present invention contemplate other methods for estimating the combustible oxygen fraction or the total energy of fuel being provided to the engine.

Further, it is understood that with reference to these five figures the terms “algorithm” and “system” are somewhat interchangeable. As one example, FIG. 7.1.3 can be considered a block diagram of a system, in which there is a combination of hardware (such as an ECM 40, fuel injector 78, and O₂ sensor 60) that are operated with driving signals that correspond to computations within the ECM software. However, FIG. 7.1.3 can also be viewed as an algorithm that relates inputs (engine speed and pedal positional) to engine performance (in terms of BSFC, BSNOx, etc.) Some of this conversion from inputs to engine outputs is provided by the thermodynamics of the engine cycle 21. In some embodiments, engine cycle 21 is a compression ignition cycle, whereas in other embodiments engine cycle 21 is a spark ignition cycle. Further, although these aforementioned cycles are typically thought of as 4-stroke, yet other embodiments of the present invention pertain to other types of cycles, including 2-stroke and 5-stroke cycles.

Note that much of the existing ECM decision-making (as represented by algorithm 105 and shown in FIG. 7.1.3), as well as many of the existing controllers are left in place in some embodiments. In one embodiment, system 105 includes an oxygen sensor 60 located so as to provide a signal 60.1 that is representative of oxygen content in the exhaust gases leaving a cylinder 22. Preferably, sensor 60 is a wide band oxygen sensor. System 105 further includes a rail pressure control loop 102 that responds to a desired rail pressure so as to increase the actual rail pressure being provided by fuel rail 24 (as seen in FIG. 7.2). This rail pressure is provided to fuel injectors 78.

In some embodiments, there are eight additional blocks which are implemented, which is by way of example only. It is understood that the concept of a “block” is a schematic representation of portions of a control algorithm, and is not necessarily representative of any specific control algorithm. FIG. 7.1.5 shows a schematic representation of control logic 110 that provides outputs including a new EGR desired fraction 111 and further an estimate of the biodiesel blend fraction 113. The biodiesel blend fraction estimator 112 provides the blend estimation 113. It utilizes the mixture fraction and the exhaust O₂ mole fraction to estimate the biodiesel blend fraction, as further discussed in PCT application PCT/09/52613, filed Aug. 3, 2009. The oxygen fraction estimator 114 block is essentially a representation of Eq. 6.1. It estimates COMF based on the exhaust O₂ mole fraction, the EGR fraction, the charge flow, and the fuel flow. The oxygen fraction calculator 116 block calculates the desired COMF by calculating what the COMF would be if the fuel were B0. The COMF target is based on Eq. 6.1 and the target outputs of the original ECM decision-making process. The oxygen fraction control 118 block is a controller that compares the estimated COMF to the desired COMF and adjusts the EGR fraction command to achieve the COMF target.

In one embodiment of the present invention, a simple proportional-integral (PI) controller was used in the oxygen fraction control block 110. These four blocks estimate the biodiesel blend fraction and transform the system from using EGR fraction as a closed-loop control targeted variable to using COMF instead. It is understood that yet other embodiments of the present invention pertain to proportional-integral-derivative (PID) controllers, as well as to other implementations of closed-loop control.

The fueling related adjustments pertaining to an energy-based control algorithm 120 are now discussed. Referring to FIG. 7.1.4, it can be seen that schematically the outputs of algorithm 120 include a desired total fueling 121.2 and a desired start of the main injection pulse 121.1, both of which are provided to algorithm 105. The total energy calculator block 122 uses the original total fueling command to calculate what the total injected fuel energy would be if the fuel were B0. The total fueling calculator 124 block calculates the new total fueling command 121.2 so that the total injected fuel energy is the same as if the fuel were B0. The combined action of the total energy calculator 122 and total fueling calculator 124 blocks is represented by Eq. 6.2. The EOMI is calculated by the end of main injection calculator 126 block which uses the original desired total fueling and the rail pressure to compute what the EOMI would be if the fuel were B0. This is done via the existing injector on-time maps. The start of main injection calculator 128 block then uses those same lookup maps to compute the new SOMI 121.1 so that the desired EOMI is achieved. The four algorithms 122, 124, 126, and 128 thus replace the control variable total injected fuel mass with total injected fuel energy, and also replace SOMI with EOMI.

The engine used for these experiments was the same engine used for the experimental work presented previously. NOx emissions in the exhaust were measured with California Analytical Instruments 600 Series Gas Analyzers. Particulate matter emissions were measured with a AVL model 483 Micro-Soot Sensor. O₂ in the exhaust was measured with a Bosch LSU 4.9 O₂ sensor (Bosch #0258017025). Fresh air flow was measured with a Meriam laminar flow element (LFE). Torque was measured via a General Electric model IG473 eddy current dynamometer. Data acquisition was completed with a dSPACE system. ECM-to-dSPACE communication took place over a CAN interface. Note that only ECM-grade measurements/estimates were used for estimation and control purposes. Lab grade equipment was only used for torque and emissions measurement purposes. The B0 fuel used was commercially available #2 diesel fuel. The B100 fuel used was soy-based methyl ester biodiesel produced by Integrity Biofuels of Morristown, Ind.

Four operating points were tested: the SET operating points A25, A100, B50, and C100. The experimental testbed was modified so that two separate fuel supply tanks could be used, one containing the B0 fuel and one containing B100 fuel. A schematic of the modified system is shown in FIG. 7.2. The modified system included an internal combustion engine 20 having a plurality of cylinders 22. Each cylinder is provided directly with fuel by a corresponding fuel injector 78. In some embodiments, injectors 78 are piezoelectrically actuated injectors that are commanded by ECM 40, and provided with fuel under pressure by fuel rail 24. A three-way valve in the fuel supply line allowed the fuel to be switched seamlessly from one fuel supply tank to the other. Note that the fuel blend being combusted in the engine changes very quickly, however it does not change instantaneously because some mixing of the fuel occurs in the fuel pump, fuel filter, fuel injection rail, etc. The fuel return line was routed into a third tank to prevent mixed fuel from contaminating either supply tank.

At each of the four operating points, two different cases were tested. In both cases, the three-way valve was used to change the fuel blend from B0 to B100 and then back to B0 over the course of 400 seconds. In the first case, the conventional stock control structure was used (block 105 in FIG. 7.1.2). In the second case, the new fuel-flexible closed-loop control structure was used. The blocks 110 and 120 shown in FIG. 7.1.2 were used to control fueling on an energy basis as well as to control EGR fraction on a COMF basis. The biodiesel blend fraction estimator utilized a Kalman-type filter.

FIG. 7.3 displays the performance of the engine with the conventional control structure 105 (i.e., without the accommodation strategies of algorithms 110 or 120 implemented) at the A25 operating point. The uppermost plot within FIG. 7.3 displays the estimated biodiesel blend fraction over the 400 seconds of the test. Note that the fuel blend was B0 initially. The 3-way valve in the fuel supply line was switched just before the 50 second mark. The time required for the fuel mixing to occur and transfer over to pure B100 was approximately 100 seconds. Just prior to the 300 second mark the 3-way valve was returned to its original position and the biodiesel blend returned to B0 before the end of the test.

FIG. 7.3 shows that, as expected with the conventional control structure, the torque decreases as the biodiesel blend fraction increases. Also as expected, the second and third plots show that BSNOₓ, increases and BSPM decreases. These results are consistent with the trends discussed earlier. FIG. 7.3 shows that, in accordance with a conventional control structure 105, EGR fraction, total fueling, and SOMI remain approximately constant for the entire test. Note that, as a result, COMF increases slightly for the higher biodiesel blend fractions.

FIG. 7.4 displays the engine behavior for the second case at A25. In this case the control variable based accommodation strategies 110 and 120 are applied. Note that now the torque does not decrease, the BSNOx does not increase, and the BSPM still decreases for the higher biodiesel blend fractions. These results are consistent with COMF, total injected fuel energy, and EOMI being held constant. Note from FIG. 7.4 that the EGR fraction increased so that COMF was held constant. Note also that the total fueling increased (so that total injected fuel energy was held constant) and the SOMI was advanced (so that EOMI was held constant). It is understood that in yet other embodiments of the present invention, there are methods for compensating the controlled amount of EGR as a function of COMF, without there being any compensation for the total energy being provided to the engine.

FIGS. 7.5 and 7.6 display the results at the A100 operating condition. As was the case at A25, the results show that with a conventional control structure higher biodiesel blend fractions produce decreases in torque and BSPM, as well as increases in BSNOx and COMF while FIG. 7.6 shows that the implementation of the accommodation algorithms 110 and 120 result in torque for biodiesel that is actually slightly increased relative to B0. This is attributable to the slight increases in brake thermal efficiency that were discussed earlier. Also note that BSNOx and BSPM are essentially constant over the entire test.

Comparable behavior is exhibited at the B50 operating condition as can be seen in FIGS. 7.7 and 7.8. A conventional control structure 105 (shown in FIG. 7.7) results in degraded torque and BSNOₓ, performance, while a control structure including algorithms 110 and 120 (shown in FIG. 7.8) displays torque and BSNOₓ, which are approximately constant regardless of the biodiesel blend fraction.

The results at the C100 operating condition (shown in FIGS. 7.9 and 7.10) are similar to the results at the other operating condition, except for that, at C100, the new control structure did not completely eliminate the increase in BSNOx. This may be due to the quality of the ECM-grade measurements used for control. Examination of the lab-grade measurements shows that the “true” EGR fraction (from lab-grade measurements) only increased about half as much as the ECM estimate of EGR fraction.

One embodiment of the present invention is an algorithm that includes an oxygen fraction estimator and closed-loop controller Preferably, the COMF and injected fuel energy-based controllers are stable existing ECM decision making/control, and response of the engine's combustion and gas exchange processes. Passivity-based analysis and control can be utilized to modify some algorithms prepared according to various embodiments of the present invention, considering that the COMF- and fuel energy-based controllers are being “folded into” pre-existing systems. Candidate COMF and fuel energy controllers are stable in and of themselves, but could be less stable when integrated with the pre-existing ECM/engine dynamics. And those embodiments in which the COMF- and fuel energy-based controllers are passive with respect to the pre-existing system, then stability can be improved.

One embodiment of the present invention includes a method for improving the combustion characteristics of a fuel in a diesel engine, the fuel selected from a group including a petroleum diesel, a biodiesel and a diesel fuel mixture including petroleum diesel and biodiesel in an unknown volumetric ratio. Other embodiments further include combusting the fuel in a diesel engine. Yet other embodiments include estimating a volumetric blend fraction of the fuel, the volumetric blend fraction representing a ratio of petroleum diesel to biodiesel in the fuel, to provide estimated volumetric blend fraction data. Still further embodiments include inputting the estimated volumetric blend fraction data into an engine control system, determining at least one optimized engine operation parameter or parameter combination based on the estimated volumetric blend fraction data, and adjusting at least one engine setting based upon the at least one optimized engine operation parameter.

Some embodiments of the present inventions pertain to methods and apparatus as described in any of paragraphs A, B, C, D, or E.

A. One embodiment of the present invention pertains to a method of controlling an internal combustion engine, comprising providing an internal combustion engine having an electronic controller for operating the engine with a first control loop closed on a first engine parameter and a second control loop closed on a second engine parameter. The method includes operating the engine with a fuel that includes a biomass-derived fuel; estimating the amount of the biomass derived fuel either with the controller or as an external input to the controller; modifying operation of the first loop in response to the estimated amount; and modifying operation of the second loop in response to the estimated amount.

B. Another embodiment of the present invention pertains to a method for controlling an internal combustion engine, comprising providing an internal combustion engine having an electronic controller operating the engine. The method includes estimating the energy content of the fuel; and operating the engine to provide a predetermined amount of energy to the engine.

C. Still another embodiment of the present invention pertains to a method of controlling an internal combustion engine, comprising providing an internal combustion engine having at least one cylinder and an electronic controller for operating the engine with at least one closed loop. The method includes operating the engine with an oxygenated fuel; computing or measuring the rate of fuel flow into the engine with the controller or as an external input to the controller; computing or measuring the oxygen content of the fuel with the controller or as an external input to the controller; computing or measuring the rate of ambient air flow into the engine with the controller or as an external input to the controller; calculating a number by the controller corresponding to the amount of combustible oxygen being provided to the cylinder; and operating the engine with the loop in response to said calculating.

D. Another embodiment of the present invention pertains to a method for controlling an internal combustion engine, comprising providing an internal combustion engine and an electronic controller operating the engine. The method includes measuring the oxygen content of the exhaust gas; determining that the fuel includes a biofuel from said measuring; and compensating at least one control schedule for the biofuel.

E. A further embodiment of the present invention pertains to a method of controlling an internal combustion engine, comprising providing an internal combustion engine having an intake manifold and an electronic controller operating the engine with an electronically actuatable fuel injector. The method includes estimating the rate of fuel flow into the engine with the controller; estimating the energy content of the fuel with the controller; estimating the rate of air flow into the intake manifold with the controller; and using at least one of the estimated fuel flow rate, estimated energy content, and estimated air flow rate and modifying operation of the engine with the injector.

It is understood that still other inventions pertain to those described in any of paragraphs A, B, C, D, or E, which further includes any one or more of the following: wherein one loop pertains to control of EGR and another control loop pertains to control of injected fuel; wherein said modifying the first loop includes increasing the amount of exhaust gas recirculated if the amount of biomass-derived fuel increases; wherein said modifying the second loop includes increasing the amount of fuel provided if the amount of biomass-derived fuel increases; wherein said increasing includes increasing the duration of the main fuel pulse; wherein said increasing includes maintaining the end of the main fuel pulse at about the same position relative to the engine cycle; wherein said increasing includes maintaining the start of the main fuel pulse at about the same position relative to the engine cycle; wherein said modifying the second loop includes moving forward within the engine cycle the pilot pulse of fuel if the amount of biomass-derived fuel increases; or wherein said providing includes an oxygen sensor disposed within the exhaust of the engine and said estimating includes using a signal received from the sensor.

It is understood that still other inventions pertain to those described in any of paragraphs A, B, C, D, or E, which further includes any one or more of the following: wherein the controller uses the estimated energy content to modify a fueling schedule; wherein said providing includes a wideband oxygen sensor for measuring oxygen content of the engine exhaust gas, said estimating uses a measurement from the sensor; wherein said operating includes increasing the duration of a pulse of fuel if the energy content of the fuel decreases; wherein said operating includes providing increases fuel earlier in the engine cycle if the energy content of the fuel decreases; or wherein said operating the engine includes moving forward within the engine cycle the pilot pulse of fuel if the energy content of the fuel decreases.

It is understood that still other inventions pertain to those described in any of paragraphs A, B, C, D, or E, which further includes any one or more of the following: wherein said modifying includes calculating a desired quantity of exhaust gas to recirculate into the engine; wherein the loop is closed to limit the oxides of nitrogen in the exhaust gas from the engine; wherein said providing includes a valve actuatable to control the flow of recirculated exhaust gas, and said modifying is by actuating the valve; wherein said calculating is by using the estimated fuel flow rate, estimated oxygen content, and estimated air flow rate; which further comprises estimating the rate of flow of recirculated exhaust gas into the engine with the controller, and said calculating is by using said estimating the flow of EGR; wherein said estimating the rate of flow of recirculated exhaust gas includes estimating the oxygen content of the recirculated exhaust gas; wherein said estimating the oxygen content of the fuel includes measuring the oxygen content of the exhaust gas from the engine; wherein said measuring oxygen content is with a wideband oxygen sensor; wherein the engine operates with compression ignition of the fuel; wherein the engine operates with spark ignition of the fuel; wherein the fuel includes biodiesel; wherein the fuel is a blend of a petroleum-based fuel and a biomass-derived fuel; wherein the rate of fuel flow is a desired rate of fuel flow; wherein said estimating the rate of fuel flow includes measuring the rate of fuel flow; wherein said estimating the rate of ambient air flow includes measuring a quantity corresponding to the rate of airflow; or wherein the quantity is manifold pressure; wherein the quantity is engine speed.

It is understood that still other inventions pertain to those described in any of paragraphs A, B, C, D, or E, which further includes any one or more of the following: wherein said compensating includes beginning the injecting of a pulse of fuel earlier in the engine operating cycle; wherein said compensating includes ending the Injecting of a pulse of fuel later in the engine operating cycle; or wherein said compensating includes increasing the pressure of fuel provided to the injector.

It is understood that still other inventions pertain to those described in any of paragraphs A, B, C, D, or E, which further includes any one or more of the following: wherein said modifying is by changing the timing of a discrete pulse of fuel provided for combustion in the engine; wherein the timing is of the start of the pulse of fuel; wherein the timing is of the end of the pulse of fuel, or wherein said modifying is by changing the pressure of fuel provided to the injector.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. A method of controlling an internal combustion engine, comprising:
providing an internal combustion engine having an electronic controller for operating the engine with a first control loop closed on the recirculation of exhaust gas and a second control loop closed on the amount of fuel provided;
operating the engine with a fuel that is a blend of a petroleum-based fuel and a biomass-derived fuel;
estimating the amount of the biomass derived fuel with the controller;
modifying operation of the first loop in response to the estimated amount; and
modifying operation of the second loop in response to the estimated amount.

2. The method of claim 1 wherein said modifying the first loop includes increasing the amount of exhaust gas recirculated if the amount of biomass-derived fuel increases.

3. The method of claim 1 wherein said modifying the second loop includes increasing the amount of fuel provided if the amount of biomass-derived fuel increases.

4. The method of claim 3 wherein said increasing includes increasing the duration of the main fuel pulse.

5. The method of claim 3 wherein said increasing includes maintaining the end of the main fuel pulse at about the same position relative to the engine cycle.

6. The method of claim 3 wherein said increasing includes maintaining the start of the main fuel pulse at about the same position relative to the engine cycle.

7. The method of claim 1 wherein said modifying the second loop includes moving forward within the engine cycle the pilot pulse of fuel if the amount of biomass-derived fuel increases.

8. The method of claim 1 wherein said providing includes an oxygen sensor disposed within the exhaust of the engine and said estimating includes using a signal received from the sensor.

9. A method for controlling an internal combustion engine, comprising:
providing an internal combustion engine having an electronic controller operating the engine with an electronically actuatable fuel injector;
estimating the energy content of the fuel; and
operating the engine to provide a predetermined amount of energy to the engine with the injector.

10. The method of claim 9 wherein the controller uses the estimated energy content to modify a fueling schedule.

11. The method of claim 9 wherein said providing includes a wideband oxygen sensor for measuring oxygen content of the engine exhaust gas, said estimating uses a measurement from the sensor.

12. The method of claim 9 wherein said operating includes increasing the duration of a pulse of fuel if the energy content of the fuel decreases.

13. The method of claim 9 wherein said operating includes providing increases fuel earlier in the engine cycle if the energy content of the fuel decreases.

14. The method of claim 9 wherein said operating the engine includes moving forward within the engine cycle the pilot pulse of fuel if the energy content of the fuel decreases.

15-16. (canceled)

17. The method of claim 1 wherein the first control loop limits the oxides of nitrogen in the exhaust gas from the engine.

18-32. (canceled)

33. A method for controlling an internal combustion engine, comprising:
providing an internal combustion engine and an electronic controller operating the engine with an electronically actuatable fuel injector;
measuring the oxygen content of the exhaust gas;
determining that the fuel includes a biofuel from said measuring; and
compensating for the biofuel by injecting additional fuel into the engine.

34. The method of claim 33 wherein said compensating includes beginning the injecting of a pulse of fuel earlier in the engine operating cycle.

35. The method of claim 33 wherein said compensating includes ending the Injecting of a pulse of fuel later in the engine operating cycle.

36. The method of claim 33 wherein said compensating includes increasing the pressure of fuel provided to the injector.

37-40. (canceled)

41. The method of claim 1 wherein said modifying the second loop includes changing the pressure of fuel provided.

42-52. (canceled)
